(19) United States
(12) Patent Application Publication
(10) Pub. No.: US 2022/0250762 A1
(43) Pub. Date: Aug. 11, 2022

(54) VEHICLE

(71) Applicant: H2GO POWER LTD, London (GB)

(72) Inventors: Luke SPERRIN, London (GB); Enass ABO-HAMED, London (GB); Peter ITALIANO, London (GB); Kieran O'DONNELL, London (GB)

(21) Appl. No.: 17/595,729

(22) PCT Filed: May 29, 2020
(86) PCT No.: PCT/GB2020/051305

§ 371 Date: Nov. 23, 2021

(30) Foreign Application Priority Data
May 30, 2019 (GB) 1907701.5
Mar. 26, 2020 (GB) 2004425.1

(51) Int. Cl. B64D 37/30; B64C 39/02; B64D 27/24; B60L 50/71; B60L 50/72; B60L 53/54

(52) U.S. Cl. CPC B64D 37/30; B64C 39/024; B64D 27/24; B64D 37/34; B60L 50/72; B60L 53/54; B64C 2201/042; B60L 50/71

(57) ABSTRACT

A vehicle (10), preferably an unmanned and/or autonomous vehicle for example an unmanned aerial vehicle, UAV, is described. The vehicle (10) comprises: a set of structural components (100), arranged to provide, at least in part, a structure of the vehicle (10) and to resist, at least in part, internal and external forces in one, two or three dimensions; a propulsion system (600), arranged to propel the vehicle (10), and/or an auxiliary power supply (700), arranged to provide electrical power to the vehicle (10); a set of hydrogen storage devices (200), including a first hydrogen storage device (200A), and optionally a set of heaters (300) including a first heater (300A), wherein the set of hydrogen storage devices (200) is arranged to provide hydrogen gas to the propulsion system (600) and/or to the auxiliary power supply (700); wherein the first hydrogen storage device (200A) comprises: a pressure vessel (230A), having a first fluid inlet (210A) and a first fluid outlet (220A), comprising therein a thermally conducting network (240A) optionally thermally coupled to the first heater (300A), wherein the pressure vessel (230A) is arranged to receive therein a hydrogen storage material in thermal contact, at least in part, with the thermally conducting network (240A); and preferably, wherein the thermally conducting network (240A) has a lattice geometry, a gyroidal geometry and/or a fractal geometry in two and/or three dimensions; and wherein the first hydrogen storage device (200A_, preferably the pressure vessel and/or the thermally conducting network (230A) thereof, provides a first structural component (100A) of the set of structural components (100).

### FIELD

The present invention relates to hydrogen vehicles, particularly to hydrogen storage devices thereof and therefor.

### BACKGROUND TO THE INVENTION

Hydrogen is an environmentally-attractive alternative fuel to fossil fuels. Importantly, hydrogen can be produced without the use of fossil fuels, such as by the electrolysis of water using renewable energy. Hydrogen has a relatively high density of energy per unit mass and is effectively non-polluting since the main combustion product is water.

Generally, hydrogen vehicles use hydrogen as onboard fuel for motive power. The propulsion systems of such hydrogen vehicles convert the chemical energy of hydrogen to mechanical energy, typically by either combusting the hydrogen in internal combustion engines or, more frequently, by reacting the hydrogen with oxygen in a fuel cell, to provide electrical power for electric motors.

While hydrogen has wide potential application as a fuel, a major drawback in its utilization for vehicles has been lack of suitable storage. Conventionally, hydrogen is stored in a pressure vessel as a compressed gas under a high pressure, for example between 350 bar and 700 bar, or stored as a cryogenic liquid. However, storage of hydrogen as a compressed gas at high pressure generally involves use of large pressure vessels, limiting utilization in vehicles and/or presenting a safety risk. Further, liquid hydrogen is expensive to produce while storage of hydrogen as a liquid presents a serious safety problem and requires storage below 20 K, thus precluding utilization in vehicles, for example. Furthermore, utilization of such conventional storage, using conventional pressure vessels or liquid hydrogen, is limited by the associated infrastructure requirements, as mandated by safety and/or cost. In addition, such conventional storage typically has a relatively low hydrogen storage density, such that the conventional storage has a relatively high mass and/or large volume for a given amount of stored hydrogen, thereby increasing hydrogen consumption, decreasing range and/or reducing payload and/or load or cargo capacity of the vehicles, for example.

Hence, there is a need to improve storage of hydrogen for hydrogen vehicles.

### SUMMARY OF THE INVENTION

It is one aim of the present invention, amongst others, to provide a vehicle which at least partially obviates or mitigates at least some of the disadvantages of the prior art, whether identified herein or elsewhere. For instance, it is an aim of embodiments of the invention to provide a vehicle having an enhanced range and/or payload, compared with vehicles having conventional storage of hydrogen. For instance, it is an aim of embodiments of the invention to provide a hydrogen storage device for vehicles having improved safety, compared with conventional hydrogen storage.

A first aspect provides a vehicle, preferably an unmanned and/or autonomous vehicle for example an unmanned aerial vehicle, UAV, the vehicle comprising:

a set of structural components, arranged to provide, at least in part, a structure of the vehicle and to resist, at least in part, internal and/or external forces in one, two or three dimensions;
a propulsion system, arranged to propel the vehicle, and/or an auxiliary power supply, arranged to provide electrical power to the vehicle;
a set of hydrogen storage devices, including a first hydrogen storage device, and optionally a set of heaters including a first heater, wherein the set of hydrogen storage devices is arranged to provide hydrogen gas to the propulsion system and/or to the auxiliary power supply; wherein the first hydrogen storage device comprises:
a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network; and preferably, wherein the thermally conducting network has a lattice geometry, a gyroidal geometry and/or a fractal geometry in two and/or three dimensions; and wherein the first hydrogen storage device, preferably the pressure vessel and/or the thermally conducting network thereof, provides a first structural component of the set of structural components.

A second aspect provides a charging station for charging a hydrogen storage device for a vehicle according to the first aspect.

A third aspect provides a charging station assembly comprising a charging station according to the second aspect and a hydrogen storage device for a vehicle according to the first aspect.

A fourth aspect provides a hydrogen storage device for a vehicle, preferably an unmanned and/or autonomous vehicle for example an unmanned aerial vehicle, UAV;

wherein the vehicle comprises a set of structural components, arranged to provide, at least in part, a structure of the vehicle and to resist, at least in part, internal and/or external forces in one, two or three dimensions; and a propulsion system, arranged to propel the vehicle, and/or an auxiliary power supply, arranged to provide electrical power to the vehicle;
wherein the hydrogen storage device is arranged to provide hydrogen gas to the propulsion system and/or to the auxiliary power supply and wherein the hydrogen storage device comprises:
a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network; and preferably, wherein the thermally conducting network has a lattice geometry, a gyroidal geometry and/or a fractal geometry in two and/or three dimensions; and wherein the hydrogen storage device, preferably the pressure vessel and/or the thermally conducting network thereof, provides a first structural component of the set of structural components.

### DETAILED DESCRIPTION OF THE INVENTION

According to the present invention there is provided a vehicle, as set forth in the appended claims. Also provided is a charging station for a vehicle and a charging station assembly comprising a hydrogen storage device for a vehicle and a charging station. Other features of the invention will be apparent from the dependent claims, and the description that follows.

### Vehicle

The first aspect provides a vehicle, preferably an unmanned and/or autonomous vehicle for example an unmanned aerial vehicle, UAV, the vehicle comprising:

a set of structural components, arranged to provide, at least in part, a structure of the vehicle and to resist, at least in part, internal and/or external forces in one, two or three dimensions; a propulsion system, arranged to propel the vehicle, and/or an auxiliary power supply, arranged to provide electrical power to the vehicle;
a set of hydrogen storage devices, including a first hydrogen storage device, and optionally a set of heaters including a first heater, wherein the set of hydrogen storage devices is arranged to provide hydrogen gas to the propulsion system, and/or to the auxiliary power supply; wherein the first hydrogen storage device comprises:
a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network; and preferably, wherein the thermally conducting network has a lattice geometry, a gyroidal geometry and/or a fractal geometry in two and/or three dimensions; and
wherein the first hydrogen storage device, preferably the pressure vessel and/or the thermally conducting network thereof, provides a first structural component of the set of structural components.

In this way, a range and/or payload of the vehicle is enhanced, since the hydrogen is stored in the hydrogen storage material, having a higher hydrogen storage density compared with conventional storage of hydrogen. That is, per unit mass and/or unit volume, the first hydrogen storage device may store more hydrogen compared with conventional high pressure storage and/or cryogenic storage. Hence, fora given amount of stored hydrogen, a mass and/or a size of the first hydrogen storage device is relatively reduced, enabling an increased payload and/or a decreased hydrogen consumption. Additionally and/or alternatively, for a given mass and/or volume of the first hydrogen storage device, an amount of stored hydrogen is relatively increased, enabling an increased range of the vehicle and/or an increased power output of the auxiliary power supply. In this way, a safety of hydrogen storage is improved, since the hydrogen is stored by the hydrogen storage material at a relatively low pressure, rather than as a highly compressed gas at a relatively high pressure or a cryogenic liquid. For example, the hydrogen stored by the hydrogen storage material may be stored at a pressure of just 5 bar while conventionally hydrogen may be stored as a compressed gas under a high pressure, for example between 350 bar and 700 bar. In this way, safety is improved since the hydrogen may be stored in the hydrogen storage device at a relatively lower pressure. For example, a hydrogen storage density of 30 g per litre for the hydrogen storage device is equivalent to storing hydrogen as a compressed gas at a pressure of about 700 bar. For example, a relatively higher hydrogen storage density of 50 g per litre for the hydrogen storage device is equivalent to storing hydrogen as a compressed gas at a pressure of about 1,300 bar, which is precluded for most or all vehicle scenarios, due to safety at least. Increasing the hydrogen storage density further to 100 g per litre for the hydrogen storage device is effectively beyond a practical limit for storing hydrogen as a compressed gas. In addition, since the hydrogen is stored at a relatively low pressure, a shape of the pressure vessel may be modified compared with a conventional high pressure cylindrical pressure vessel having dished ends, such that the hydrogen storage device may provide the first structural component. Furthermore, the range may be increased also compared with Li-ion polymer batteries, for a given mass, for example by up to 85% for a UAV and with a higher payload. In addition, a lifetime of the first hydrogen storage device may be increased compared with Li-ion polymer batteries, for example by a factor of 3, and/or a recharging time may be reduced, for example by a factor of 10. Additionally, a cost saving of more than 60% may be achieved using the first hydrogen storage device, compared with Li-ion polymer batteries. That is, by storing the hydrogen using the hydrogen storage material in the pressure vessel of the first hydrogen storage device, a hydrogen storage capacity is improved while a storage pressure is reduced, compared with conventional storage of hydrogen, thereby enhancing safety while increasing a range and/or a payload and/or decreasing a fuel consumption of the vehicle. Since the first hydrogen storage device provides the first structural component, the first hydrogen storage device thus is an integral part of a structure of the vehicle. In this way, a structural integrity of the vehicle is improved while a mass of the vehicle is reduced, thereby increasing a range and/or a payload and/or decreasing a fuel consumption of the vehicle.

### Vehicle

In one example, the vehicle comprises and/or is a hydrogen vehicle, using hydrogen as onboard fuel, at least in part, for motive power. In one example, the vehicle is a hybrid hydrogen/electric vehicle using hydrogen as onboard fuel, at least in part, for motive power and stored electrical power, for example from batteries, at least in part, for motive power.

In one example, the vehicle is an aircraft, for example a fixed wing aircraft, a rotary wing aircraft (also known as rotorcraft) or an airship. Advantageously, a range and/or payload of the aircraft may be increased, as described previously, compared with conventional hydrogen storage, for example. Furthermore, a safety of the aircraft may be enhanced, thereby reducing risk due to collision and/or crash landing, for example. In one example, the vehicle is a watercraft, such as a surface watercraft, for example a boat, a ship or a hovercraft, or a submersible watercraft, for example a submarine. Advantageously, a range of the watercraft may be increased and/or a hydrogen consumption reduced, as described previously, compared with conventional hydrogen storage, for example. In one example, the vehicle is a land craft. In one example, the land craft is a two-wheeled vehicle such as a scooter or a motorbike, a three-wheeled vehicle, a four-wheeled vehicle such as an automobile, a van, a bus, a truck, a forklift truck, a military vehicle, or a vehicle having more than two axles, such as a lorry, a tram or a train. Advantageously, a range of the land craft may be increased and/or a hydrogen consumption reduced, as described previously, compared with conventional hydrogen storage, for example.

### Unmanned and Autonomous Vehicles

The vehicle is preferably an unmanned and/or autonomous vehicle for example an unmanned aerial vehicle, UAV. Generally, an unmanned vehicle (also known as an uncrewed vehicle) is a vehicle without a person on board. An unmanned vehicle can either be a remote controlled vehicle (also known as a remote guided vehicle) or an autonomous vehicle, capable of sensing its environment and navigating autonomously. Unmanned vehicles includes unmanned ground vehicle (UGV), such as the autonomous car; unmanned aerial vehicle (UAV) (also known as a drone), unmanned surface vehicle (USV), for the operation on the surface of the water; unmanned underwater vehicle (UUV) sometimes known as underwater drone, for the operation underwater; remotely operated underwater vehicle (ROUV); autonomous underwater vehicle (AUV); and unmanned spacecraft, both remote controlled (“unmanned space mission”) and autonomous (“robotic spacecraft” or “space probe”). Generally, autonomous vehicles are capable of sensing their environment and navigating autonomously. For example, autonomous cars (also known as self-driving cars) combine a variety of sensors to perceive their surroundings, such as RADAR, LIDAR, SONAR, GPS, odometry and inertial measurement units, while advanced control systems interpret the sensory information to identify appropriate navigation paths, as well as obstacles.

Preferably, the vehicle is a UAV. An unmanned aerial vehicle (UAV), commonly known as a drone, is an aircraft without a human pilot on board. UAVs are a component of an unmanned aircraft system (UAS); which include a UAV, a ground-based controller, and a system of communications between the two. The flight of UAVs may operate with various degrees of autonomy: either under remote control by a human operator or autonomously by onboard computers. Compared with manned aircraft, UAVs were originally used for missions too ‘dull, dirty or dangerous’ for humans. While they originated mostly in military applications, their use is rapidly expanding to commercial, scientific, recreational, agricultural, and other applications, such as policing, peacekeeping, and surveillance, product deliveries, aerial photography, smuggling, and drone racing. Civilian UAVs now vastly outnumber military UAVs. UAVs typically fall into one of six functional categories (although multi-role airframe platforms are becoming more prevalent): target and decoy (providing ground and aerial gunnery a target that simulates an enemy aircraft or missile); reconnaissance (providing battlefield intelligence); combat (providing attack capability for high-risk missions); logistics (delivering cargo); research and development (improve UAV technologies); civil and/or commercial UAVs (for example, agriculture, aerial photography, data collection). In one example, the vehicle is a logistics and/or a civil and/or commercial UAV. UAVs may be classified according to gross take off weight (GTOW): micro air vehicle (MAV) (the smallest UAVs that can weigh less than 1 g); miniature UAV (also called SUAS) (approximately less than 25 kg); and heavier UAVs (i.e. 25 kg or more). In one example, the UAV is a miniature UAV or a heavier UAV. In one example, the UAV has a GTOW in a range from 2.5 kg to 2500 kg, preferably in a range from 5 kg to 500 kg, more preferably in a range from 10 kg to 125 kg, most preferably in a range from 12.5 kg to 50 kg; and/or a payload in a range from 0.5 kg to 500 kg, preferably in a range from 1 kg to 250 kg, more preferably in a range from 2 kg to 100 kg, most preferably in a range from 3 kg to 25 kg; and/or a flight time (i.e. a maximum flight duration) in a range from 0.5 hours to 24 hours, preferably in a range from 0.75 hours to 12 hours, more preferably in a range from 1 hour to 4 hours. Particularly, adoption of UAVs requires increased payload and/or flight time, as provided by the vehicle according to the first aspect.

### Structural Components

The vehicle comprises the set of structural components, arranged to provide, at least in part, the structure of the vehicle and to resist, at least in part, internal and/or external forces in one, two or three dimensions. That is, the set of structural components provide the structural integrity of the vehicle.

Typically, the set of structural components of an aircraft includes an airframe comprising a fuselage and a fixed wing and/or a rotary wing. Fuselage components include stringers, longerons, ribs, bulkheads, frames and formers. The main component of a fixed wing is a wing spar. Typically, the set of structural components of a surface watercraft include a hull comprising a bottom, sides, a deck and/or a keel, and optionally a superstructure. Typically, the set of structural components of a submersible watercraft include a hull, for example a single hull or a double hull. Typically, the set of structural components of a land craft includes a chassis. The chassis, also known as a vehicle frame, is the main supporting structure of the vehicle and functions to, inter alia, support the vehicle's mechanical components and body, deal with static and dynamic loads, without undue deflection or distortion, vertical and torsional twisting transmitted by going over uneven surfaces, transverse lateral forces caused by road conditions, side wind, and steering the vehicle, torque from the engine and transmission, longitudinal tensile forces from starting and acceleration, as well as compression from braking and/or sudden impacts from collisions. In other words, the first structural component performs one or more of these functions. Types of chassis include unibody (also known as monocoque), ladder type frame, X-Type frame, off set frame, off set with cross member frame and perimeter frame.

Propulsion System and/or Auxiliary Power Supply

The vehicle comprises the propulsion system, arranged to propel the vehicle, and/or the auxiliary power supply, arranged to provide electrical power to the vehicle. Typically, propulsion systems of hydrogen vehicles convert the chemical energy of hydrogen to mechanical energy, typically by either combusting the hydrogen in internal combustion engines or by reacting the hydrogen with oxygen in a fuel cell, to provide electrical power for electric motors. In one example, the propulsion system comprises a heat engine, for example an internal combustion engine, and/or a fuel cell. Fuel cells are preferred. Typically, auxiliary power supplies of vehicles provide electrical power for starter motors, engines or turbines, control and/or safety systems, heating, ventilation and air conditioning (HVAC) and/or backup power.

In one example, the propulsion system and/or the auxiliary power supply comprises: a set of electrical generators, including a first electrical generator, configured to generate electricity using the hydrogen gas, selected from a group comprising a fuel cell and an electrical generator comprising a heat engine, for example an internal combustion engine. In this way, electrical power may be generated by the set of electrical generators, using the hydrogen gas released from the hydrogen storage material as a fuel. It should be understood that the set of electrical generators is coupled to the set of hydrogen storage devices via respective fluid couplings.

In one example, the first electrical generator is an electrical generator comprising a heat engine, for example comprising an internal combustion engine arranged to combust the hydrogen and a generator, moved by the internal combustion engine. Other electrical generators and/or heat engines are known.

In one example, the first electrical generator is the fuel cell, selected from a group comprising a proton exchange membrane fuel cell, PEMFC, an alkaline fuel cell, AFC, and a phosphoric acid fuel cell, PAFC. In this way, electrical power may be generated without moving parts, compactly, at relatively low temperatures and/or efficiently. PEMFCs, also known as polymer electrolyte membrane (PEM) fuel cells, are generally constructed from membrane electrode assemblies (MEA) which include electrodes, electrolyte, catalyst and gas diffusion layers. Typically, an ink of catalyst, carbon, and electrode are deposited onto a solid electrolyte and carbon paper is hot pressed on either side to protect the inside of the cell and also act as electrodes. The fundamental part of the PEMFC is a triple phase boundary (TPB) where the electrolyte, catalyst, and reactants mix and thus where cell reactions occur. The membrane must not be electrically conductive so half reactions do not mix. Generally, operating temperatures above 100° C. are desired so the water byproduct becomes steam and water management becomes less critical in PEMFC design. Suitable PEMFCs are available from Ballard Power Systems Inc. (Burnaby, Canada) such as the FCgen and FCvelocity series, and Horizon Fuel Cell Technologies (Singapore) such as the Aerostacks and H-Series. AFCs (also known as Bacon fuel cells) are cheap to manufacture and have efficiencies of up to 70%. PAFCs use liquid phosphoric acid as an electrolyte, are CO₂ tolerant and have efficiencies of up to 70%. Since PAFCs typically operate at 150 to 200° C., expelled steam may be used for air and water heating. Suitable PAFCs are available from Doosan Fuel Cell America, Inc. (CT, USA) and Fuji Electric Co. Ltd (Tokyo, Japan).

### Hydrogen Storage Device

The vehicle comprises the set of hydrogen storage devices, including the first hydrogen storage device, and optionally the set of heaters including the first heater, wherein the set of hydrogen storage devices is arranged to provide hydrogen gas to the propulsion system and/or to the auxiliary power supply.

In one example, the set of hydrogen storage devices includes M hydrogen storage devices, wherein M is a natural number of at least 1, for example 1, 2, 3, 4, 5, 6, 7, 8, 9, 10 or more. In this way, a hydrogen storage capacity of the vehicle may be matched to a requirement, for example.

### Hydrogen Storage Density

In one example, the first hydrogen storage device has a hydrogen storage density of at least 0.01 wt. %, at least 0.1 wt. %, at least 1.0 wt. %, at least 1.8 wt. %, preferably at least 2.4 wt. %, more preferably at least 3.3 wt. %, most preferably at least 5.5 wt. %, by wt. % of the first hydrogen storage vessel. In one example, the first hydrogen storage device has a hydrogen storage density of at most 50 wt. %, at most 40 wt. %, at most 30 wt. %, at most 25 wt. %, preferably at most 20 wt. %, more preferably at most 15 wt. %, most preferably at most 12.5 wt. %, by wt. % of the first hydrogen storage vessel. In this way, the hydrogen storage density may exceed energy storage in a Li-ion polymer battery (about 1.8 wt. % hydrogen storage density equivalent) and may exceed hydrogen storage density in a conventional compressed hydrogen cylinder at 300 bar, thereby increasing a range and/or a payload of the vehicle, as described previously.

TABLE 1
Example of increase in payload for a 15.5 kg gross take off weight
(GTOW) hexicopter (i.e. an aircraft) including a 2.2 kW fuel cell
for various hydrogen storage densities, according to exemplary
embodiments. A hydrogen storage density of 1.8 wt. % is equivalent
to a Li-ion polymer battery while a hydrogen storage density of
5.5 wt. % is equivalent to a 700 bar compressed hydrogen cylinder.

| | Hydrogen storage density | | | |
|---|---|---|---|---|
| | 1.8 wt. % | 2.4 wt. % | 3.3 wt. % | 5.5 wt. % |
| Core system | 5.9 kg | 5.9 kg | 5.9 kg | 5.9 kg |
| Fuel cell | 4.2 kg | 4.2 kg | 4.2 kg | 4.2 kg |
| H2 + tank | 5.4 kg | 4.1 kg | 3.0 kg | 1.8 kg |
| (700 bar) | | | | |
| Payload | 0.0 kg | 1.3 kg | 2.4 kg | 3.6 kg |

TABLE 2
Comparison of a 15.5 kg gross take off weight (GTOW) hexicopter
(i.e. an aircraft) for a 1 hour flight time: a Li-ion polymer
6S16P (2.5 Ah/cell) system comparative example compared with
a 2.2 kW fuel cell and a hydrogen storage density of 5.5 wt.
% according to an exemplary embodiment. The hydrogen-fuelled
aircraft has a 3.6 kg payload while the Li-ion polymer powered
aircraft has a zero payload for the 1 hour flight duration.

| | | Example |
|---|---|---|
| | Comparative example | Hydrogen storage density |
| | Li-ion polymer battery | 5.5 wt. % |
| Li-ion polymer battery | 9.6 kg | — |
| Core system | 5.9 kg | 5.9 kg |
| Fuel cell | — | 4.2 kg |
| H2 + tank (700 bar) | — | 1.8 kg |
| Payload | 0.0 kg | 3.6 kg |

### Hydrogen Storage Capacity

In one example, the first hydrogen storage device has a hydrogen storage capacity in a range from 1 g to 2,500 g, preferably in a range from 5 g to 1,000 g, more preferably in a range from 20 g to 500 g. Typically, 1 kg hydrogen may provide about 16.65 kWh of electrical energy, assuming a 50% efficiency in converting from chemical energy of the hydrogen to electrical energy, for example via a fuel cell. In this way, the first hydrogen storage device may provide an amount of electrical energy, via a fuel cell for example, in a range from 0.01665 kWh to 41.625 kWh, preferably in a range from 0.08325 kWh to 16.65 kWh, more preferably in a range from 0.333 kWh to 8.325 kWh.

### Pressure Vessel

The first hydrogen storage device comprises the pressure vessel, having the first fluid inlet and the first fluid outlet. In contrast to conventional pressure vessels for storage of compressed hydrogen gas, the pressure vessel is designed according to a relatively low operating pressure of at most 100 bar, preferably at most 75 bar, more preferably at most 50 bar, even more preferably at most 25 bar, most preferably at most 10 bar. Generally, a conventional pressure vessel for high pressure storage of hydrogen (i.e. 350 bar to 700 bar) is cylindrical, having dished ends. In contrast, since the pressure vessel is designed according to a relatively low operating pressure, a shape of the pressure vessel may be varied, while still maintaining an integrity and/or safety factor thereof. For example, the pressure vessel may be cuboidal such as a square based prism, thereby increasing space utilisation and/or enabling stacking thereof. For example, the pressure vessel may shaped aerodynamically (for example, for aircraft and land craft) or hydrodynamically (for water craft), such that the pressure vessel may provide and/or conform with an outer surface of the vehicle. In one example, the first hydrogen storage device, for example the pressure vessel, has at most two planes of symmetry, preferably having a shape arranged to reduce drag (i.e. shaped aerodynamically or hydrodynamically), in use. In one example, the pressure vessel has a moment of inertia I>½ MR² about its central axis, where M is the mass of the pressure vessel and R is the mean radius of the pressure vessel, normal to the central axis. It should be understood that the moment of inertia I is determined for the empty pressure vessel shell i.e. not including the thermally conducting network, the hydrogen storage material, hydrogen, the first inlet and the first outlet. In one example, the pressure vessel comprises an insulating layer, arranged to thermally insulate the pressure vessel. In this way, control of a temperature of the pressure vessel is improved. In one example, the pressure vessel comprises a double wall (i.e. an inner pressure wall and an outer wall, for example an outer skin). In this way, a gap between the double wall may provide an insulating layer and/or comprise an insulating layer. In one example, one or more components of the vehicle are arranged in the gap within the double wall. In one example, the outer wall may be shaped aerodynamically or hydrodynamically and/or the inner wall is cylindrical, having dished ends. In this way, a wall thickness of the inner wall may be reduced for a given operating pressure, while the outer wall reduces drag. In addition, the outer wall may provide a physical buffer, reducing damage to the inner wall. In one example, the pressure vessel comprises a passageway arranged, for example axially, to receive the first heater therein. In one example, the passageway is a blind passageway. In one example, the passageway is a through passageway. In one example, the first heater comprises a Joule heater, for example a cartridge heater, and/or a recirculating heater, for example recirculating liquid, and the pressure vessel is arranged, for example comprising a passageway, to interchangeably receive the Joule heater and the recirculating heater therein and/or thereon. For example, the pressure vessel may comprise a through passageway, arranged to receive a cartridge heater inserted therein through an end of the passageway and the opposed end of the passageway may be closed, for example with an insulating plug. Alternatively, the cartridge heater and the plug may be removed and fluid couplings instead fitted to the ends, such that a recirculating liquid, such as heated coolant (i.e. a heating fluid) from a fuel cell to heat the thermally conducting network, may be pumped therethrough. In this way, flexibility for heating and/or cooling the thermally conducting network is provided. In one example, the first hydrogen storage device comprises a passageway, wherein the first hydrogen storage device is arrangeable in: a first configuration to receive a Joule heater in the passageway; and a second configuration to receive a flow of a liquid through the passageway.

It should be understood that the first fluid inlet and the first fluid outlet are for the inlet of hydrogen into the pressure vessel and outlet of hydrogen from the pressure vessel, respectively, such as provided, at least in part, by a perforation (i.e. an aperture, a passageway, a hole) through a wall of the pressure vessel. In one example, the first fluid inlet and the first fluid outlet are a gas inlet and a gas outlet, respectively. In one example, the first fluid inlet and the first fluid outlet are provided by and/or via the same perforation. In one example, the pressure vessel has a plurality of gas inlets and/or gas outlets, including the first gas inlet and the first gas outlet respectively. In one example, the first fluid inlet and the first fluid outlet comprise releasable couplings, thereby providing coupling thereto and uncoupling therefrom, for example repeatedly, of corresponding couplings. Suitable releasable couplings (also known as fittings or connectors) include push-fit fittings, bayonet fittings, quick connect fittings, cylinder connections to BS341 or DIN 477, hose end fittings, pipe end fittings, tube end fittings and screw fittings. Other releasable couplings are known. In one example, the first hydrogen storage device comprises one or more of a thermocouple, a thermowell, a valve, a flashback arrestor, a filter such as a sorbent protection filter, a pressure sensor and a mass flow controller (MFC), for example inline with the first releasable fluid inlet coupling. A valve is generally movable between an open position in which hydrogen can enter or exit the vessel, and a closed position in which the vessel is sealed. In one example, the valve is electrically and/or pneumatically actuatable. In this way, the valve may be actuated remotely, for example via a controller. In one example, the MFC is electrically actuatable. In this way, the MFC may be actuated remotely, for example via a controller, to control flow of hydrogen therethrough.

### Hydrogen Storage Material

The pressure vessel is arranged to receive therein the hydrogen storage material in thermal contact, at least in part, with the thermally conducting network.

As an alternative to storage of hydrogen as a compressed gas or as a liquid, certain metals and alloys permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a solid hydride, a greater volumetric storage density may be achieved than possible for hydrogen as a compressed gas or as a liquid. In addition, hydrogen storage as a solid hydride presents a reduced safety risk compared with storing hydrogen as a compressed gas or as a liquid. In one example, the hydrogen storage material comprises and/or is a solid hydride.

For example, solid-phase metal or alloy materials can store large amounts of hydrogen by absorbing hydrogen with a high density and by forming a metal hydride under a specific temperature/pressure or electrochemical conditions, and hydrogen can be released by changing these conditions.

Generally, an efficiency of exchange of hydrogen into and out of such storage materials may be enhanced or inhibited by their respective heat transfer capabilities. Particularly, hydriding (also known as hydrogen absorption) is exothermic while dehydriding (also known as hydrogen desorption) is endothermic. Therefore, moving heat within such storage materials or maintaining preferred temperature profiles across and through volumes of such storage materials becomes a crucial factor in such metal or alloy hydride hydrogen storage materials. As a general matter, release of hydrogen from the crystal structure of a metal hydride requires input of some level of energy, normally heat. Placement of hydrogen within the crystal structure of a metal, metal alloy, or other storage system generally releases energy, normally heat, providing a highly exothermic reaction of hydriding or placing hydrogen atoms within the crystal structure of the hydrideable alloy.

The heat released from hydriding of hydrogen storage metals or alloys may be removed. Heat ineffectively removed can cause the hydriding process to slow down or terminate. This becomes a serious problem which prevents fast charging. During fast charging, the hydrogen storage material is quickly hydrogenated and considerable amounts of heat are produced. The hydrogen storage device described herein, particularly the thermally conducting network, provides for effective removal of the heat caused by the hydriding of the hydrogen storage alloys to facilitate fast charging of the hydride material. Approaches to this issue have been reported, for example in US 2003/0209149 and in “Heat transfer techniques in metal hydride hydrogen storage: A review”, Afzal et al., International Journal of Hydrogen Energy, 2017, 42(52), 30661-30682.

The hydrogen storage devices described herein allow for rapid charging and discharging of hydrogen gas while may also be relatively compact. Typically, heat is applied to discharge hydrogen gas, and heat is released and needs to be absorbed (for example, cooling applied) during hydrogen charging. The hydrogen storage devices allow for rapid heating and/or cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

The hydrogen storage material in the device of the invention can be a compound that is a metal hydride. Typically, the elemental metal reacts with hydrogen to form a metal hydride, for example:

Mg+H₂→MgH2

Generally, this reaction may be driven forwards by increasing hydrogen pressure.

Release of hydrogen occurs when heat is applied to the hydride. For example, for magnesium hydride and at 1 bar of pressure, MgH₂ decomposes to Mg metal and hydrogen at 287° C.:

MgH₂→Mg+H₂

In one example, the hydrogen storage material comprises one or more selected from: a metal for example an alkaline metal, an alkaline earth metal and/or a transition metal; and/or a hydride salt of a metal for example a hydride salt of an alkaline metal, an alkaline earth metal and/or a transition metal and/or a complex salt thereof; and/or a borohydride salt of a metal for example an alkaline metal, an alkaline earth metal and/or a transition metal; and/or a borohydride salt of ammonium and/or alkyl ammonium; and/or mixtures thereof. In one example, the hydrogen storage material comprises an ABₓ alloy, wherein A is at least one selected from a group consisting of La, Ce, Pr, Nd, Ca, Y, Zr, and Mischmetal, wherein B is at least one selected from a group consisting of Ni, Co, Mn, Al, Cu, Fe, B, Sn, Si, Ti, and x is in a range from 4.5 to 5.5. In one example, the hydrogen storage material comprises an AB/A₂B alloy, wherein A is at least one selected from a group consisting of Ti and Mg, and B is at least one selected from a group consisting of Ni, V, Cr, Zr, Mn, Co, Cu, and Fe. In one example, the hydrogen storage material comprises an AB₂ alloy, wherein A is at least one selected from a group consisting of Ti, Zr, Hf, Th, Ce and rare earth metals, and B is at least one selected from a group consisting of Ni, Cr, Mn, V, Fe, Mn and Co. In one example, the hydrogen storage material comprises an ABₓ alloy, an AB/A₂B alloy, an AB₂ alloy, a hydride and/or a mixture thereof, as described above and/or below. In one example, the hydrogen storage material comprises at least one selected from a group consisting of Pd, Pt, Ni, Ru, and Re. In one example, the hydrogen storage material comprises one or more metal hydrides selected from a group consisting of: lithium hydride (LiH), sodium hydride (NaH), potassium hydride (KH), beryllium hydride (BeH₂), magnesium hydride (MgH₂), calcium hydride (CaH₂), strontium hydride (SrH₂), titanium hydride (TiH₂), aluminum hydride (AlH₃), boron hydride (BH₃), lithium borohydride (LiBH₄), sodium borohydride (NaBH₄), magnesium borohydride (Mg(BH₄)₂), calcium borohydride (Ca(BH₄)₂), lithium alanate (LiAlH₄), sodium alanate (NaAlH₄), magnesium alanate (Mg(AlH₄)₂), calcium alanate (Ca(AlH₄)₂), and mixtures thereof. In one example, the hydrogen storage material comprises one or more metal hydrides selected from MgH₂, NaAlH₄, LiAlH₄, LiH, LaNi₅H₆, TiFeH₂, palladium hydride PdHₓ, LiNH₂, LiBH₄ and NaBH₄. MgH₂, NaAlH₄, LiAlH₄, LiH and/or LaNi₅H₆ are preferred. In one example, the hydrogen storage material comprises a mixture of two or more of these metal hydrides. These different metal hydrides may have different storage and/or release rates. Hence, a mixture of two or more of these metal hydrides may be selected for desired storage and/or release rates, for example under different conditions, and/or to provide relatively more constant storage and/or release rates under different conditions. In one example, the hydrogen storage material comprises a dopant such as a catalyst and/or an additive. For example, Ti and/or Zr may be used as catalytic dopants to improve kinetics of hydrogen storage and/or release, such as of sodium alanate. Although alkali metal alanates were known as non-reversible ‘chemical hydrides’, catalysed reversibility offers the possibility of a new family of low-temperature hydrides. For example, the alkali metal alanate-complex hydride, NaAlH₄, readily releases and absorbs hydrogen when doped with a TiCl₃ or Ti-alkoxide catalysts. There is currently ongoing research looking into optimisation of these catalysts in terms of their type, doping process and mechanistic understanding. Generally any appropriate transition or rare-earth metal can be used as catalysts, for example Ti, Zr, V, Mn, Fe, Ni, Co, Cr, Nb, Ge, Ce, La, Nd, Pd, Pr, Zn, Al, Ag, Ga, In and/or Cd. Additives include C, which improves thermal transfer of the hydrogen storage material. In one example, the hydrogen storage material is provided as particles (for example, in a powder form). In one example, the particles are microparticles, having a D50 or a D90 of at most 500 μm, at most 250 μm, at most 100 μm or at most 50 μm. In one example, the particles are microparticles having a D50 or a D10 of at least 1 μm, at least 5 μm, at least 10 μm or at least 25 μm. In one example, the particles are nanoparticles having a D50 or a D90 of at most 500 nm, at most 250 nm, at most 100 nm or at most 50 nm. In one example, the particles are nanoparticles having a D50 or a D10 of at least 1 nm, at least 5 nm, at least 10 nm or at least 20 nm. In one example, the particles are a mixture of particles of different sizes, for example a mixture of microparticles and nanoparticles, thereby having a bimodal particle size distribution. In this way, a packing efficiency for example a density and/or a surface area of the particles may be increased, thereby increasing storage of hydrogen and/or a rate of storage of hydrogen respectively. In one example, the hydrogen storage material is processed, for example by attrition such as ball milling, to reduce a particle size thereof and/or a particle size distribution thereof and/or to incorporate a dopant and/or an additive.

As an alternative to storage of hydrogen as a compressed gas or as a liquid, certain unsaturated organic compounds permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a LHOC, a greater volumetric storage density may be achieved than possible for hydrogen as a compressed gas or as a liquid. In addition, hydrogen storage as a LOHC presents a reduced safety risk compared with storing hydrogen as a compressed gas or as a liquid. In one example, the hydrogen storage material comprises and/or is a LOHC.

For example, unsaturated organic compounds can store large amounts of hydrogen by absorbing hydrogen with a high density and by forming saturated organic compounds under a certain temperature/pressure conditions, and hydrogen can be released by changing these conditions.

Generally, an efficiency of exchange of hydrogen into and out of such storage materials may be enhanced or inhibited by their respective heat transfer capabilities. Particularly, hydrogenation (loading of LOC to LOHC, thereby storing hydrogen) is exothermic and dehydrogenation (unloading of LOHC to LOC, thereby releasing hydrogen) is endothermic. Therefore, moving heat within such storage materials or maintaining preferred temperature profiles across and through volumes of such storage materials becomes a crucial factor in such hydrogen storage materials.

Heat ineffectively supplied or removed causes hydrogenation and dehydrogenation to slow down or terminate. This becomes a serious problem which prevents fast charging and release. During fast charging and release, considerable amounts of heat are required to heat and cool the LOC and LOHC, respectively, and particularly, should be supplied homogeneously given the relatively low thermal conductivity of LOC and LOHC. The hydrogen storage device described herein, particularly the thermally conducting network, provides for effective heating and cooling of the hydrogen storage material to facilitate fast charging and release.

The hydrogen storage devices described herein allow for rapid charging and discharging of hydrogen gas while may also be relatively compact. The hydrogen storage devices allow for rapid heating and cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

In one example, the LOHC comprises and/or is a saturated cycloalkene, aromatic, heterocyclic aromatic and/or a mixture thereof. It should be understood that LOHC generally refers to the hydrogenated (i.e. loaded, saturated) liquid organic compound while LOC generally refers to the dehydrogenated (i.e. unloaded, unsaturated) liquid organic compound. However, in practice, a given molecular name may be used interchangeably to refer to both, with the correct meaning understood by the skilled person in the given context. Hence, for example, N-ethylcarbazole (NEC) may be referred to commonly as a LOHC yet is unsaturated. Research on LOHC was initially focussed on cycloalkanes, having a relatively high hydrogen capacity (6-8 wt. %) and production of COx-free hydrogen. Heterocyclic aromatic compounds (or N-Heterocycles) are also appropriate. N-Ethylcarbazole (NEC) is a well-known LOHC but many other LOHCs are known. With a wide liquid range between −39° C. (melting point) and 390° C. (boiling point) and a hydrogen storage density of 6.2 wt. %, dibenzyltoluene is ideally suited as LOHC material. Formic acid has been suggested as a promising hydrogen storage material with a 4.4 wt. % hydrogen capacity. Using LOHCs relatively high gravimetric storage densities can be reached (about 6 wt. %) and the overall energy efficiency is higher than for other chemical storage options such as producing methane from the hydrogen.

In one example, the LOHC comprises and/or is N-ethylcarbazole (NEC), monobenzyltoluene (MBT), dibenzyltoluene (DBT), 1,2-dihydro-1,2-azaborine (AB), toluene (TOL), naphthalene (NAP), benzene, phenanthrene, pyrene, pyridine, chinoline, fluorene, carbazole, methanol, formic acid, phenazine, ammonia and/or mixtures thereof. Cycloalkanes reported as LOHCs include cyclohexane, methyl-cyclohexane and decalin. The dehydrogenation of cycloalkanes is highly endothermic (63-69 kJ/mol H₂), which means this process requires relatively high temperatures and/or heat inputs. Dehydrogenation of decalin is the most thermodynamically favored among the three cycloalkanes, and methyl-cyclohexane is second because of the presence of the methyl group. Ni, Mo and Pt based catalysts have been investigated for dehydrogenation. However, coking is still a big challenge for catalyst's long-term stability. Generally, hydrogenation and dehydrogenation of LOHCs requires catalysts. It was demonstrated that replacing hydrocarbons by hetero-atoms, like N, O etc. improves reversible de/hydrogenation properties. The temperature required for hydrogenation and dehydrogenation drops significantly with increasing numbers of heteroatoms. Among all the N-heterocycles, the saturated-unsaturated pair of dodecahydro-N-ethylcarbazole (12H-NEC) and NEC has been considered as a promising candidate for hydrogen storage with a fairly large hydrogen content (5.8 wt %). The standard catalyst for NEC to 12H-NEC is Ru and Rh based. The selectivity of hydrogenation can reach 97% at 7 MPa and 130° C. to 150° C. Although N-heterocyles can optimize the unfavorable thermodynamic properties of cycloalkanes, challenges include relatively high cost, high toxicity and/or kinetic barriers. Use of formic acid as a hydrogen storage material has been reported. Carbon monoxide free hydrogen has been generated in a very wide pressure range (1-600 bar). A homogeneous catalytic system based on water-soluble ruthenium catalysts selectively decompose HCOOH into H₂ and CO₂ in aqueous solution. This catalytic system overcomes the limitations of other catalysts (e.g. poor stability, limited catalytic lifetimes, formation of CO) for the decomposition of formic acid making it a viable hydrogen storage material. The co-product of this decomposition, carbon dioxide, can be used as hydrogen vector by hydrogenating it back to formic acid in a second step. The catalytic hydrogenation of CO₂ has long been studied and efficient procedures have been developed. Formic acid contains 53 g L⁻¹ hydrogen at room temperature and atmospheric pressure. By weight, pure formic acid stores 4.3 wt. % hydrogen. Pure formic acid is a liquid with a flash point 69° C. However, 85% formic acid is not flammable. Ammonia (NH₃) releases H₂ in an appropriate catalytic reformer. Ammonia provides high hydrogen storage densities as a liquid with mild pressurization and cryogenic constraints: It can also be stored as a liquid at room temperature and pressure when mixed with water. Ammonia is the second most commonly produced chemical in the world and a large infrastructure for making, transporting, and distributing ammonia exists. Ammonia can be reformed to produce hydrogen with no harmful waste.

In use, during storage of hydrogen, hydrogen may be received into the first vessel of the first hydrogen storage device via the first fluid inlet, for example from a hydrogen gas generator, as described below. Preferably, the first hydrogen storage device is initially in a fully discharged state. When the hydrogen comes into contact with the hydrogen storage material, a temperature of the hydrogen storage material increases due to the exothermic absorption (i.e. hydriding) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first fluid inlet may be opened, to admit the hydrogen, and closed, to contain the hydrogen, for example when a pressure within the first vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydriding.

In use, during release of hydrogen (i.e. desorption), a reverse process to storage occurs. A valve inline with the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

In one example, the first hydrogen storage device comprises and/or is a static first hydrogen storage device. In such a static device, a predetermined volume of LOHC (for example, corresponding with at most an open volume of the first vessel) is received in the first vessel through the first fluid inlet and heated, via the thermally conducting network, thereby releasing hydrogen gas, which exits the first vessel via the first fluid outlet. When all the hydrogen is released from the LOHC, only liquid organic carrier, LOC, (i.e. unloaded LOHC) remains in the first vessel, and may be discharged (for example, for reloading) via the first fluid outlet or reloaded in the first vessel. Alternatively, in such a static device, a predetermined volume of liquid organic carrier, LOC, is received in the first vessel through the first fluid inlet together with hydrogen gas and heated and cooled, via the thermally conducting network, thereby storing the hydrogen gas in the LOC as the LOHC. When the LOC is fully loaded, only loaded LOHC remains in the first vessel. Hence, it should be understood that in the static device, the LOHC (or LOC) does not flow through the first vessel while releasing (or charging, respectively) the hydrogen. In one example, the static first hydrogen storage device comprises a mixer or stirrer, for mixing or stirring the LOHC (or LOC) therein, thereby improving an efficiency of dehydrogenation (or hydrogenation), respectively.

In contrast, in one example, the first hydrogen storage device comprises and/or is a dynamic (also known as flow-through) first hydrogen storage device. In such a dynamic device, a flow of LOHC is received, for example continuously, into the first vessel through the first fluid inlet and heated, via the thermally conducting network, thereby releasing hydrogen gas, which exits the first vessel together with the LOC (i.e. the unloaded LOHC) through the first fluid outlet. Alternatively, in such a dynamic device, a pressurised flow of LOC is received in the first vessel together with a flow of hydrogen gas and heated and cooled, via the thermally conducting network, thereby storing the hydrogen gas in the loaded LOC as the LOHC, which exits the first vessel through the first fluid outlet. Hence, it should be understood that in the dynamic device, the LOHC (or LOC) flows through the first vessel while releasing (or charging, respectively) the hydrogen. In one example, the first hydrogen storage device comprises a pump arranged to flow the hydrogen storage material through the first vessel.

In one example, the first hydrogen storage device comprises, is and/or is known as a reactor.

In one example, the pressure vessel comprises a lid (also known as a cover or a blanking plate, for example for an access hatch or an aperture in a wall of the pressure vessel) sealing coupled thereto and/or thereon, thereby providing a sealed pressure vessel around the thermally conducting network. The hydrogen storage material is advantageously added, generally in powder form, before the lid is sealing coupled to the pressure vessel. For example, if the hydrogen storage material is in powder form, the powder may be poured between arms of the thermally conducting network and optionally, into a foam to partially (i.e. at least 25%, preferably at least 35%, more preferably at least 45% by volume of voids), in a majority (i.e. at least 50%, preferably at least 60%, more preferably at least 70%, most preferably at least 80% by volume of voids), substantially (i.e. at least 90%, preferably at least 95%, more preferably at least 97.5% by volume of voids) and/or completely fill the pressure vessel. By filling the voids substantially with the powder, a hydrogen storage capacity is increased. Conversely, by filling the voids partially with the powder, heat transfer with the thermally conducting network may be improved. This filling may generally be carried out in an inert atmosphere environment, such as under argon, or other inert gas, before sealing the lid on the pressure vessel. Depending on the scale of manufacture, this may be carried out in a glove box. Slight agitation, for example vibration, can be advantageous, to ensure the powder percolates through the thermally conducting network and/or foam. In one example, the hydrogen storage device comprises an agitator, for example a vibrator, mechanically coupled to the pressure vessel and/or the thermally conductive network, arranged to agitate, for example vibrate, the pressure vessel and/or the thermally conductive network to thereby increase a filling efficiency of the pressure vessel with the hydrogen storage material.

In use, during storage of hydrogen, hydrogen may be received into the pressure vessel of the first hydrogen storage device via the first fluid inlet, for example from a hydrogen gas generator, as described below. Preferably, the first hydrogen storage device is initially in a fully discharged state. When the hydrogen comes into contact with the hydrogen storage material, a temperature of the hydrogen storage material increases due to the exothermic absorption (i.e. hydriding) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first fluid inlet may be opened, to admit the hydrogen, and closed, to contain the hydrogen, for example when a pressure within the pressure vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydriding.

In use, during release of hydrogen (i.e. desorption), a reverse process to storage occurs. A valve inline with the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

### Thermally Conducting Network

The pressure vessel comprises therein the thermally conducting network thermally coupled to the first heater. In one example, a face of the thermally conducting network is in thermal contact (and hence thermally coupled to) the first heater. In one example, the first heater is integrally formed with and/or in the thermally conducting network, at least in part. For example, the first heater may be embedded within (i.e. internal to) the thermally conducting network.

The thermally conducting network may be formed from any suitable thermally conducting material for example a metal such as aluminium, copper, respective alloys thereof such as brass or bronze alloys of copper and/or stainless steel. Preferred materials also do not react with and/or are not embrittled by hydrogen and/or the hydrogen storage material, while having sufficient strength to maintain a structural integrity of the thermally conducting network. In one example, the thermally conducting network comprises a coating to reduce reaction with and/or embrittlement by hydrogen.

Preferably, the thermally conducting network has a lattice geometry, a gyroidal geometry and/or a fractal geometry in two and/or three dimensions.

In one example, the thermally conducting network has a lattice geometry, a gyroidal geometry and/or a fractal geometry in two and/or three dimensions (i.e. mutually orthogonal dimensions). It should be understood that such geometries comprise a plurality of nodes, having thermally conducting arms (i.e. generally elongated members) therebetween, with voids (i.e. gaps, space) between the arms. Such geometries, particularly the fractal geometry, provide relatively high surface area to volume ratios, enables especially efficient heat transfer to and from the hydrogen storage material. In one example, the fractal geometry is selected from a group consisting of a Gosper Island, a 3D H-fractal, a Quadratic Koch Island, a Quadratic Koch surface, a Von Koch surface, a Koch Snowflake, a Sierpinski carpet, a Sierpinski tetrahedron, a Mandelbox, a Mandelbulb, a Dodecahedron fractal, a Icosahedron fractal, a Octahedron fractal, a Menger sponge and a Jerusalem cube. Certain fractal geometries, such as Gosper islands, allow for a plurality of individual repeat unit blocks to be fabricated and then assembled together in a tessellation (i.e. assembled together with no overlaps or gaps). This enables a plurality of channels to be provided in the thermally conducting network through the hydrogen storage device, whereby each channel has a high surface area, is of the same construction but does not leave wasted space between repeat units. In one example, an effective density (also known as lattice volume ratio) of the lattice geometry is uniform in one, two or three dimensions (i.e. mutually orthogonal dimensions). A gyroid is an infinitely connected triply periodic minimal surface, similar to the lidnoid which is also within the scope of the first aspect. The gyroid separates space into two oppositely congruent labyrinths of passages, through which the hydrogen storage material may flow. In one example, an effective density of the lattice geometry is non-uniform in one, two or three dimensions (i.e. mutually orthogonal dimensions). It should be understood that a uniform effective density in a particular dimension provides a constant void fraction, between arms of the lattice geometry, in the particular dimension. Conversely, it should be understood that a non-uniform effective density in a particular dimension provides a non-constant void fraction, between arms of the lattice geometry, in the particular dimension. A higher effective density will lead to faster heat conduction due to a higher thermally conducting material content. For example, the effective density may increase or decrease in the particular dimension, for example radially. In this way, the thermally conducting network may be designed, for example optimised, for a particular pressure vessel geometry so as to improve, for example optimise, heat transfer to and/or from the hydrogen storage material via the thermally conducting network. In one example, an effective density of the lattice geometry is uniform in a first dimension, for example axially, and non-uniform in mutually orthogonal second and third dimensions, for example radially. While the surface area to volume ratios of lattice geometries, for example square lattice geometries such as three-dimensional cages, are relatively lower than of fractal geometries having the same volumes, forming and/or fabrication of lattice geometries is relatively less complex and/or costly and hence may be preferred. In one example, the lattice geometry is Bravais lattice for example a triclinic lattice such a primitive triclinic lattice; a monoclinic lattice such as a primitive triclinic lattice or a base-centred triclinic lattice; an orthorhombic lattice such as a primitive orthorhombic lattice a base-centred orthorhombic lattice, a body-centred orthorhombic lattice or a face-centred orthorhombic lattice; a tetragonal lattice such as a primitive tetragonal lattice or a body-centred tetragonal lattice; a hexagonal lattice such as a primitive hexagonal lattice or a rhombohedral primitive lattice; or a cubic lattice such as a primitive cubic lattice, a body-centred cubic lattice or a face-centred cubic lattice. Other lattices are known. Hence, these Bravais lattices, for example define a plurality of regularly-arranged nodes having thermally conducting arms therebetween. In one example, the thermally conducting arms have a cross sectional dimension (for example a diameter or a width) in a range from 0.1 mm to 10 mm, preferably in a range from 0.25 mm to 5 mm, more preferably in a range from 0.5 mm to 2.5 mm and/or a length in range from 0.5 mm to 50 mm, preferably in a range from 1 mm to 25 mm, more preferably in a range from 2 mm to 10 mm. In this way, heat transfer of the thermally conducting network may be controlled by selecting an effective density and/or a surface area of the thermally conducting network.

In one example, the thermally conducting network is formed, at least in part, by 3D printing (i.e. additive manufacturing), for example by selective laser melting (SLM), thereby enabling forming of complex shapes in three dimensions having internal voids, for example. In one example, the thermally conducting network is formed, at least in part, by casting such as investment casting, moulding such as injection moulding and extrusion. Other additive manufacturing processes are known. In one example, the thermally conducting network is formed, at least in part, by fabrication and/or machining such as milling, turning or drilling. Other subtractive manufacturing processes are known. In one example, the thermally conducting network comprises fluidically interconnected passageways therein, for flow therethough of a fluid, such as a heating fluid and/or a coolant, preferably a liquid for example a recirculating liquid. In this way, heating and/or cooling of the thermally conducting network may be accelerated.

In one example, the thermally conducting network is thermally coupleable to an external surface of the vehicle. In this way, the external surface may provide a heat sink so as to remove heat from the thermally conducting network and hence cool the hydrogen storage material, for example during charging.

In one example, the thermally conducting network is thermally coupleable to the propulsion system and/or to the auxiliary power supply. In this way, excess heat from the propulsion system and/or the auxiliary power supply may be supplied to the thermally conducting network and hence heat the hydrogen storage material, for example during release.

In one example, the thermally conducting network is alternately thermally coupleable to an external surface of the vehicle and to the propulsion system and/or to the auxiliary power supply. In this way, charging and release of the hydrogen storage material may be improved.

### Foam

In one example, the hydrogen storage device comprises a thermally-conducting foam, for example a metal foam, attached to (i.e. thermally coupled to, in thermal contact with) the thermally conducting network. The inventors have found that such a foam aids heat transfer to and from the hydrogen storage material. It is known that such a foam has a high internal surface area. In one example, the foam comprises and/or is an open-celled foam, preferably an open-celled metal foam (also known as a metal sponge. Open-cell metal foams are generally manufactured by foundry or powder metallurgy. In the powder method, “space holders” are used; they occupy the pore spaces and channels. In casting processes, foam is typically cast with an open-celled polyurethane foam skeleton. The inventors have found that the hydrogen storage material may be placed in the spaces (i.e. voids, lumens, pores, cells) in the foam and the hydrogen storage material retains its ability to store and release hydrogen whilst at the same time benefiting from the enhanced rate of thermal transfer brought about by the high surface area of the foam. It should be understood that a foam pore size (i.e. cell size) is larger than a size of the hydrogen storage material, for example particles thereof. In one example, a ratio of the foam pore size to a particle size is at least 5:1, for example at least 10:1, for example 20:1, wherein sizes (i.e. foam pore size and particle size) are measurements in one dimension, for example diameter. In one example, the foam comprises and/or is a metal foam, preferably an open-celled metal foam, formed from aluminium, copper, stainless steel, nickel or zinc (or combination alloys including those metals). Aluminium foam is especially preferred. The thermally conducting network preferably contains metal foam in the spaces in the network. The voids in the metal foam contain the hydrogen storage material. It has been found that the metal foam in the fractal network provides excellent transfer of heat to and from the thermoelectric heater/cooler and the hydrogen storage material.

### Unfilled Volume

In one example, the hydrogen storage device is arranged to be oriented horizontally or vertically, in use. In one example, the thermally conducting network partially fills an internal volume of the pressure vessel, of at least 50%, preferably of at least 60%, more preferably of at least 70% by volume of the pressure vessel, thereby defining an unfilled volume above the thermally conducting network. In one example, the unfilled volume acts as a buffer, providing a reservoir of hydrogen during charging and similarly during release, for example to account for kinetics thereof. In one example, the pressure vessel comprises a mesh or a perforated sheet, arranged to cover an open area of the thermally conducting network (i.e. not thermally coupled to the pressure vessel, for example), to thereby retain the hydrogen storage material in the voids defined within the thermally conducting network.

### Heater

The power supply optionally comprises the set of heaters including the first heater. In one example, the power supply comprises the set of heaters including the first heater and the thermally conducting network is thermally coupled to the first heater. By heating the first heater, heat is transferred to the thermally conducting network thermally coupled thereto. In turn, heat is transferred to the hydrogen storage material in thermal contact, at least in part, with the thermally conducting network. In this way, the hydrogen storage material is heated by the first heater, via the thermally conducting network, thereby causing hydrogen to be released from the hydrogen storage material. In one example, the first heater is positioned inside the pressure vessel. In one example, the first heater is positioned outside of the pressure vessel. Positioning the first heater outside the pressure vessel simplifies certain aspects of the assembly of the device and allows simpler access for electrical wiring. In one example, the first heater comprises and/or is a thermoelectric heater and/or a Joule heater, and/or a recirculating heater, for example recirculating liquid, and the first vessel is arranged, for example comprising a passageway, to interchangeably receive the Joule heater and the recirculating heater therein and/or thereon. For example, the first vessel may comprise a through passageway, arranged to receive a cartridge heater inserted therein through an end of the passageway and the opposed end of the passageway may be closed, for example with an insulating plug. Alternatively, the cartridge heater and the plug may be removed and fluid couplings instead fitted to the ends, such that a recirculating liquid, such as heated coolant (i.e. a heating fluid) from a fuel cell to heat the thermally conducting network, may be pumped therethrough. In this way, flexibility for heating and/or cooling the thermally conducting network is provided. In one example, the first hydrogen storage device comprises a passageway, wherein the first hydrogen storage device is arrangeable in: a first configuration to receive a Joule heater in the passageway; and a second configuration to receive a flow of a liquid through the passageway. Other heaters are known. In one example, the power supply comprises a thermocouple connected to the first heater, for example via a proportional-integral-derivative (PID) control. In this way, a temperature of the first heater may be controlled. In one example, the first heater comprises and/or is a cartridge heater or an insertion heater. Generally, cartridge heaters are elongated cylinders including electrical resistive wire, for example embedded in magnesium oxide. Suitable cartridge heaters and insertion heaters are available from Watlow (MO, USA). In one example, the first heater is inserted into a passageway formed in and/or provided by the thermally conducting network. In one example, the first heater is integrated into the thermally conducting network, for example integrally formed therewith. In this way, a heating efficiency of the thermally conducting network is improved. In one example, the power supply comprises a battery, preferably a rechargeable battery for example a Li-ion polymer battery, arranged to provide electrical power to the first heater.

In one example, the first hydrogen storage device comprises a set of heater/coolers, including the set of heaters, including a first heater/cooler, comprising the first heater. By cooling the first heater/cooler, heat is transferred from the thermally conducting network thermally coupled thereto. In turn, heat is transferred from the hydrogen storage material in thermal contact, at least in part, with the thermally conducting network. In this way, the hydrogen storage material is cooled by the first heater/cooler, via the thermally conducting network, thereby allowing hydrogen to be stored in the hydrogen storage material. In other words, the first heater/cooler can, in a space-efficient manner, enable heat to be removed from the hydrogen storage material during the hydrogen storage phase, and heat to be supplied to the hydrogen storage material during hydrogen release. In one example, the first heater/cooler is positioned inside the pressure vessel. In one example, the first heater/cooler is positioned outside of the pressure vessel. Positioning the first heater/cooler outside the pressure vessel simplifies certain aspects of the assembly of the device and allows simpler access for electrical wiring. Thermoelectric heater and/or cooler devices can be very closely controlled (i.e. accurately, precisely and/or responsively), which providing control to a high degree of accuracy, precision and/or short response times. The heater of the first heater/cooler may be as described above with respect to the first heater. In one example, the cooler of the first heater/cooler comprises and/or is a heat sink, optionally with active cooling by air propelled by a fan or by a cooling fluid (e.g. water) being propelled by a pump. In one example, the first heater/cooler comprises and/or is a Peltier device or other device that makes use of thermoelectric cooling and heating. Devices of this type are commonly referred to as a Peltier heat pump, a solid state refrigerator, or a thermoelectric cooler (TEC). A thermoelectric heater and cooler device may be used together with a heat sink with optional active cooling (e.g. active cooling by air propelled by a fan or active cooling by a cooling fluid (e.g. water) being propelled by a pump). Application of heat or removal of heat on the side of the thermoelectric device that is not thermally coupled to the thermally conducting network enhances the ability of the thermoelectric device to heat and cool the thermally conducting network. In one example, the first heater/cooler (e.g. a thermoelectric heater and cooler) is in thermal contact with the thermally conducting network. As the two are in thermal contact, heat can efficiently be passed from one to the other. The heat can pass in either direction—heating the thermally conducting network or cooling it. The contact between the heater/cooler module and the thermally conducting network need not be direct physical contact. In some embodiments, there are intervening materials, such as a wall of the pressure vessel. In such an embodiment, the intervening material must continue to allow for good thermal contact between the heater/cooler module and the thermally conducting network, such that heat can pass efficiently from one to the other. Suitable thermoelectric heater and/or cooler devices are known to the person skilled in the art and they are available commercially from most electronics suppliers, such as CUI Inc (OR, USA). In one example, the first hydrogen storage device comprises one or more of thermoelectric heaters and/or coolers on a base to provide a Peltier heater/cooler assembly, wherein the thermally conducting network is thermally coupled (for example, attached) to the Peltier heater/cooler assembly. For example, the thermally conducting network may be 3D printed onto the heater/cooler assembly. Optionally, foam (for example metal foam, as described below) may be attached to the thermally conducting network, for example by application of an appropriate amount of compression. Alternatively, the foam may be attached by a physical bond for example by soldering, brazing and/or welding the thermally conducting network and foam together. In such an arrangement, it is preferred for the solder and/or filler to have high thermal conductivity, which is the case for most solder and filler materials.

In one example, the first heater comprises a Joule heater and/or a recirculating heater, preferably wherein the first hydrogen storage device, for example the pressure vessel, is arranged to interchangeably receive the Joule heater and the recirculating heater therein and/or thereon, as described above.

### First Structural Component

The first hydrogen storage device, preferably the pressure vessel and/or the thermally conducting network thereof, provides the first structural component of the set of structural components. In this way, the first hydrogen storage device, preferably the pressure vessel and/or the thermally conducting network thereof, stores hydrogen and contributes to a structural integrity of the vehicle. It should be understood that the first hydrogen storage device provides the first structural component or a part thereof. In one example, the first hydrogen storage device and a second hydrogen storage device provide the first structural component. In one example, the set of hydrogen storage devices, or a subset thereof, provides the first structural component. In one example, the first hydrogen storage device provides the first structural component or a part thereof and a second structural component or a part thereof. In one example, the propulsion system and/or the auxiliary power supply is coupled, for example releasably coupled, to the first hydrogen storage device. In this way, the first hydrogen storage device may be uncoupled from the propulsion system and/or from the auxiliary power supply, for example for charging and the propulsion system and/or the auxiliary power supply recoupled to another first hydrogen storage device. In one example, a second structural component of the set of structural components is coupled, for example releasably coupled, to the first hydrogen storage device. In this way, modularity of the vehicle and/or upgradeability of the vehicle may be provided. In one example, the first hydrogen storage device comprises a major portion, for example by volume and/or by mass, of the vehicle, for example at least 50%, at least 55%, at least 60% or at least 65% by volume and/or by mass of the vehicle. In this way, the vehicle may be built around the first hydrogen storage device.

In one example, the vehicle is an aircraft, for example a fixed wing aircraft or a rotary wing aircraft, and wherein the first structural component defines an airframe, a fuselage, a fixed wing and/or a part thereof, as described above. In one example, the hydrogen storage device provides a first structural component, particularly a fixed wing, of the set of structural components of the vehicle. In one example, a wall of the pressure vessel of the hydrogen storage device provides an aerofoil, thereby defining upper, lower, leading and trailing edges, of the fixed wing. In one example, the pressure vessel comprises a tube having a circular cross-section, arranged to receive a first heater therein, providing a wing spar. In one example, the thermally conducting network has a lattice geometry in three-dimensions. In one example, the thermally conducting network is formed, at least in part, by 3D printing. In one example, the thermally conducting network is thermally coupled to an external surface of the vehicle by being thermally coupled to an internal surface of the pressure vessel. In one example, the thermally conducting network is thermally coupled to the tube, providing the wing spar. In one example, the lattice geometry is a body-centred cubic lattice.

In one example, the vehicle is a watercraft, such as a surface watercraft or a submersible watercraft, and wherein the first structural component defines a hull or part thereof, as described above.

In one example, the vehicle is a land craft and wherein the first structural component defines a chassis or part thereof, as described above.

### Controller

In one example, the vehicle comprises a controller configured to control the first heater based, at least in part, on a power output of the propulsion system and/or of the auxiliary power supply. In this way, release of hydrogen from the hydrogen storage material may be pre-emptively controlled, for example increased, so as to fulfil the predicted rate of energy usage by the propulsion system and/or by the auxiliary power supply, thereby reducing latency of the release of the hydrogen. Conversely, release of hydrogen from the hydrogen storage material may be pre-emptively controlled, for example decreased, so as to still fulfil the predicted rate of energy usage by the propulsion system and/or by the auxiliary power supply, thereby reducing surplus hydrogen release. In one example, the controller is configured to control the set of heaters, as described with respect to the first heater, collectively and/or independently. In this way, respective heaters of the first set of heaters may be controlled in unison and/or individually, thereby improving granularity of control.

In one example, the controller is configured to control the first heater based, at least in part, on a predicted rate of power output of the propulsion system and/or of the auxiliary power supply. In this way, the rate of hydrogen release may be matched to the rate and/or the predicted rate of usage of energy usage by the propulsion system and/or of the auxiliary power supply, thereby reducing hydrogen consumption, since surplus hydrogen release may be avoided.

In one example, the controller is configured to control a cooler, as described previously, based, at least in part, on a predicted rate of energy usage by the propulsion system and/or by the auxiliary power supply. In this way, release of hydrogen from the hydrogen storage material may be pre-emptively controlled, as described with respect to the first heater mutatis mutandis.

In one example, the controller is configured to determine, for example calculate or estimate, a predicted energy usage by the propulsion system and/or by the auxiliary power supply (i.e. predicted power demand). For example, the controller may determine the predicted rate of energy usage by the propulsion system and/or by the auxiliary power supply by learning energy requirements of the vehicle, for example by applying machine learning algorithms to the vehicle's energy usage. In one example, the controller is configured to obtain the energy requirements of the vehicle by measuring the vehicle's energy usage.

In one example, the controller is configured to iteratively determine the predicted rate of energy usage by the propulsion system and/or by the auxiliary power supply, for example using a feedback loop,

In one example, the controller is configured to determine, for example calculate or estimate, the predicted rate of energy usage by the propulsion system and/or by the auxiliary power supply using a generalized linear model (GLM), a random forest, logistic regression, a support vector machine, K-nearest neighbours, a decision tree, AdaBoost, XGBoost, a neural network for example a convolutional neural network, time-series classification, a recurrence plot, a linear mixed model, or an ensemble of two or more thereof. XGBoost and GLM are preferred. For example, the controller may comprise a computer device including 32×2.4 GHz processors and 32 GB RAM and computations may be performed with R using GLM and/or XGBoost; alternatively and/or additionally with Python, using Keras, Theanos and/or TensorFlow.

In this way, by determining a predicted rate of energy usage by the propulsion system and/or by the auxiliary power supply, the controller may control the power supply dynamically, responsive to changes in an actual rate of energy usage by the propulsion system and/or by the auxiliary power supply, for example using a feedback loop. In this way, the rate of hydrogen gas generation may be matched to the rate and/or the predicted rate of usage of electrical power and/or the availability of energy for electrolysis, thereby improving an efficiency of hydrogen consumption.

### Charging Station

The second aspect provides a charging station for charging a hydrogen storage device for a vehicle according to the first aspect. In one example, the charging station is arranged to charge a plurality of hydrogen storage devices, for example simultaneously. In one example, the charging station comprises a manifold coupleable to a plurality of hydrogen storage devices. In one example, the charging station comprises a cooling system, arranged to cool a hydrogen storage device during charging thereof. In one example, the cooling system comprises a fan, a bath, a cooling jacket and/or a recirculating coolant system.

### Vehicle Assembly

The third aspect provides a charging station assembly comprising a charging station according to the second aspect and a hydrogen storage device for a vehicle according to the first aspect.

### Hydrogen Storage Device

The fourth aspect provides a hydrogen storage device for a vehicle, preferably an unmanned and/or autonomous vehicle for example an unmanned aerial vehicle, UAV; wherein the vehicle comprises a set of structural components, arranged to provide, at least in part, a structure of the vehicle and to resist, at least in part, internal and/or external forces in one, two or three dimensions; and a propulsion system, arranged to propel the vehicle, and/or an auxiliary power supply, arranged to provide electrical power to the vehicle;

wherein the hydrogen storage device is arranged to provide hydrogen gas to the propulsion system and/or to the auxiliary power supply and wherein the hydrogen storage device comprises:
a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network; and preferably, wherein the thermally conducting network has a lattice geometry, a gyroidal geometry and/or a fractal geometry in two and/or three dimensions; and
wherein the hydrogen storage device, preferably the pressure vessel and/or the thermally conducting network thereof, provides a first structural component of the set of structural components.

The hydrogen storage device and/or the vehicle may be as described with respect to the first aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 is a CAD exploded, perspective view of a vehicle according to an exemplary embodiment;

FIG. 2 is a CAD axial cross-section of a hydrogen storage device of the vehicle of FIG. 1, arranged in a first configuration;

FIG. 3 is a CAD axial cross-section of the hydrogen storage device of the vehicle of FIG. 1, arranged in a second configuration;

FIG. 4 schematically depicts a cutaway, perspective view of a simulation of the of the hydrogen storage device of the vehicle of FIG. 1;

FIG. 5 is a graph of flight time as a function of payload for exemplary embodiments and for a comparative example;

FIG. 6A is a schematic axial cross-section of a hydrogen storage device for a vehicle according to an exemplary embodiment and FIGS. 6B to 6D are schematic transverse cross-sections of the hydrogen storage device of FIG. 6A;

FIGS. 7A to 7C schematically depict thermally conducting networks for a hydrogen storage device for a vehicle according to an exemplary embodiment;

FIG. 8A is a photograph of a foam for a hydrogen storage device for a vehicle according to an exemplary embodiment; and FIG. 8B is a schematic view of a hydrogen storage device for a vehicle according to an exemplary embodiment, in more detail;

FIG. 9A is a plan elevation view of a hydrogen storage device for a vehicle according to an exemplary embodiment; and FIG. 9B is a side cross-sectional view of the hydrogen storage device of FIG. 9A;

FIG. 10 is a CAD cutaway perspective view of a hydrogen storage device for a vehicle according to an exemplary embodiment;

FIG. 11 is a CAD axial cross-section of the hydrogen storage device of FIG. 10;

FIG. 12 is a CAD radial cross-section of the hydrogen storage device of FIG. 10;

FIG. 13 is an alternative CAD radial cross-section of the hydrogen storage device of FIG. 10;

FIG. 14 is a CAD cutaway perspective view of a hydrogen storage device fora vehicle according to an exemplary embodiment;

FIG. 15 is a CAD axial cross-section of the hydrogen storage device of FIG. 14;

FIG. 16 is a CAD radial cross-section of a thermally conducting network of the hydrogen storage device of FIG. 14;

FIG. 17 schematically depicts Bravais lattices for a thermally conducting network;

FIG. 18 is a CAD perspective view of a hydrogen storage device for a vehicle according to an exemplary embodiment;

FIG. 19 is a CAD axial cross-section of the hydrogen storage device of FIG. 18;

FIG. 20 is a CAD axial cross-section of a hydrogen storage device for a vehicle according to an exemplary embodiment;

FIG. 21 is a CAD perspective view of a vehicle according to an exemplary embodiment;

FIG. 22 is a CAD perspective view of the vehicle of FIG. 21, in more detail;

FIG. 23 is a CAD cutaway perspective view of a vehicle according to an exemplary embodiment;

FIG. 24 is a CAD perspective cross-section view of hydrogen storage device for a vehicle according to an exemplary embodiment;

FIG. 25 is a CAD cross-section view of the hydrogen storage device for a vehicle of FIG. 24;

FIG. 26 is a CAD perspective view of a charging station assembly according to an exemplary embodiment;

FIG. 27A is a cutaway perspective view of a hydrogen storage device for a vehicle according to an exemplary embodiment; and FIG. 27B is a cutaway perspective exploded view of a related hydrogen storage device;

FIG. 28 is a cutaway perspective view of a hydrogen storage device for a vehicle according to an exemplary embodiment; and

FIG. 29A is a CAD partial cutaway perspective view of a hydrogen storage device for a vehicle according to an exemplary embodiment; FIG. 29B is a CAD longitudinal perspective cross-sectional view of the hydrogen storage device; and FIG. 29C is a CAD perspective view of the thermally conducting network, in more detail.

### DETAILED DESCRIPTION OF THE DRAWINGS

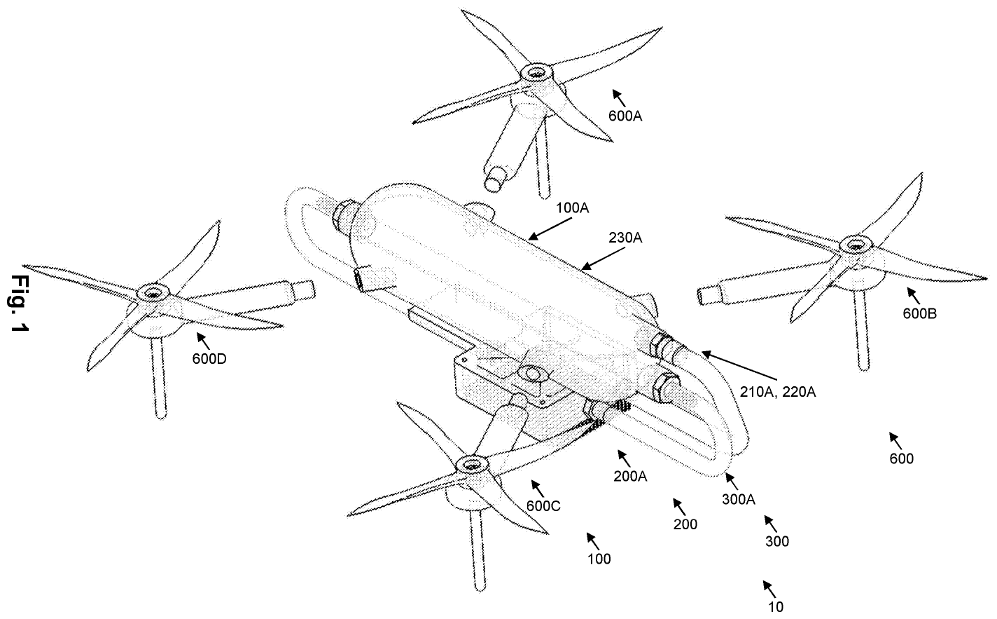

FIG. 1 is a CAD exploded, perspective view of a vehicle 10 according to an exemplary embodiment. In this example, the vehicle 10 is an unmanned aerial vehicle (UAV), particularly a quad copter. The vehicle 10 comprises: a set of structural components 100, arranged to provide, at least in part, a structure of the vehicle 10 and to resist, at least in part, internal and external forces in one, two or three dimensions; a propulsion system 600 (comprising four propulsion sub-systems 600A, 600B, 600C, 600D), arranged to propel the vehicle 10; a set of hydrogen storage devices 200, including a first hydrogen storage device 200A, and optionally a set of heaters 300 including a first heater 300A, wherein the set of hydrogen storage devices 200 is arranged to provide hydrogen gas to the propulsion system 600; wherein the first hydrogen storage device 200A comprises: a pressure vessel 230A, having a first fluid inlet 210A and a first fluid outlet 220A, comprising therein a thermally conducting network 240A (not shown) thermally coupled to the first heater 300A, wherein the pressure vessel 230A is arranged to receive therein a hydrogen storage material in thermal contact, at least in part, with the thermally conducting network 240A; and preferably, wherein the thermally conducting network 240A has a lattice geometry in three dimensions; and wherein the first hydrogen storage device 200A, particularly the pressure vessel thereof, provides a first structural component 100A of the set of structural components 100. In this example, the vehicle 10 does not comprise an auxiliary power supply 700, which is additional and/or alternative to the propulsion system 600.

In this example, the propulsion system 600 is releasably coupled to the first hydrogen storage device 200A. In this example, the first hydrogen storage device 200 comprises a set of 4 female coupling members arranged to receive corresponding male coupling members of detachable rotor arms (i.e. the four propulsion sub-systems 600A, 600B, 600C, 600D) of the vehicle 10. In this example, the first hydrogen storage device 200A comprises a major portion, of at least 65% by mass of the vehicle.

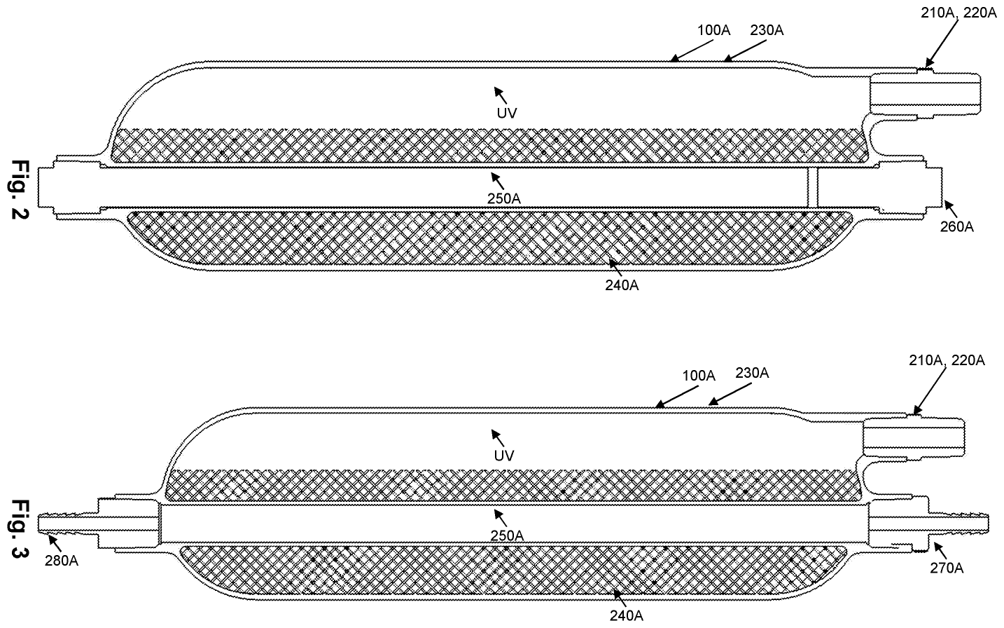

FIG. 2 is a CAD axial cross-section of a hydrogen storage device 200A of the vehicle 10 of FIG. 1, arranged in a first configuration. FIG. 3 is a CAD axial cross-section of the hydrogen storage device 200A of the vehicle 10 of FIG. 1, arranged in a second configuration. In this example, the first hydrogen storage device 200A comprises a passageway 250A, wherein the first hydrogen storage device 200A is arrangeable in: a first configuration to receive a Joule heater in the passageway 250A; and a second configuration to receive a flow of a liquid through the passageway 250A. In the first configuration, a cartridge heater (not shown) is insertable into the passageway 250A through an end thereof and the opposed end of the passageway 250A is closed, with an insulating plug 260A. In the second configuration, the cartridge heater and the plug 260A are removed and fluid couplings 270A, 280A instead fitted to the ends, such that a recirculating liquid, such as coolant from a fuel cell, may be pumped therethrough.

In this example, the hydrogen storage device 200A is arranged to be oriented horizontally, in use. In this example, the pressure vessel 230A is generally cylindrical, having dished ends. In this example, the passageway, provided by a tube having a circular cross-section, extends between the dished ends longitudinally, offset from an axis of the pressure vessel 230A. In this example, the thermally conducting network 240A partially fills an internal volume of the pressure vessel 230A, particularly a region of the internal volume extending across about 75% of a diameter the pressure vessel, thereby completely surrounding the tube, such that an unfilled volume UV above the thermally conducting network 240A is defined. In this example, the thermally conducting network 240A is thermally coupled to at least a part of an internal surface of the pressure vessel 230A and an external surface of the tube. In this example, the unfilled volume UV acts as a buffer, providing a reservoir of hydrogen during charging and similarly during release, for example to account for kinetics thereof.

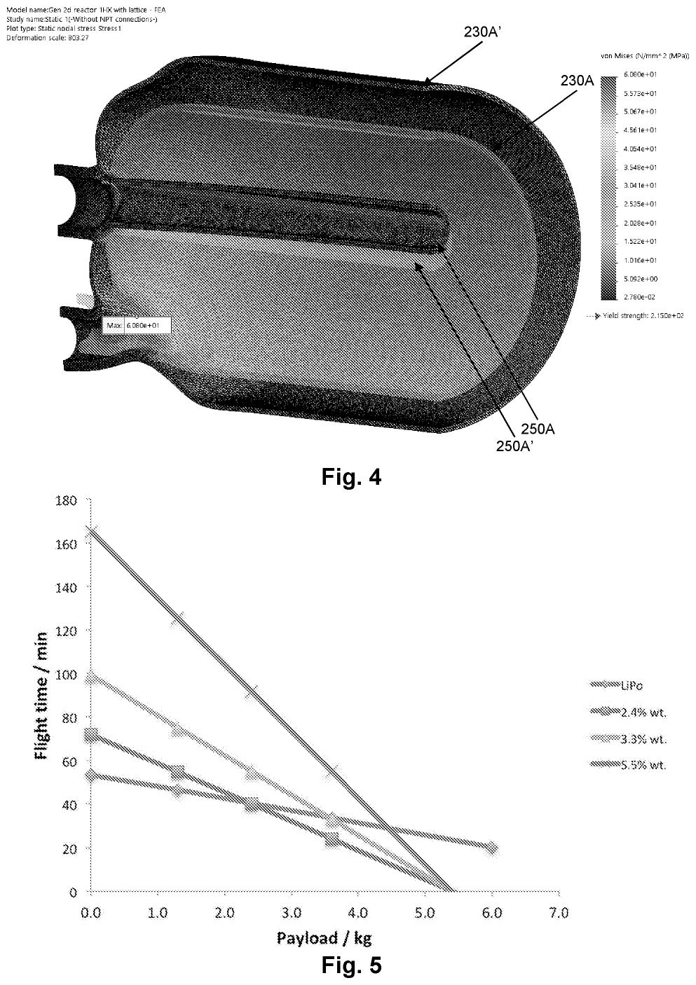

FIG. 4 schematically depicts a cutaway, perspective view of a simulation, particularly by finite element analysis (FEA) the hydrogen storage device of the vehicle of FIG. 1. In this example, the pressure vessel is generally cylindrical, having a wall thickness of 2 mm, and hemispherical dished ends, having a wall thickness of 1.5 mm. In this example, the pressure vessel is formed from a material having a yield stress at 100° C. of 181 MPa. In this example, a maximum stress at an operating pressure of 20 bar is 61 MPa, giving a safety factor of about 3. In this example, a maximum stress at an operating pressure of 5 bar is 15.2 MPa, giving a safety factor of about 11.9. Also shown is the deformed pressure vessel 230A′ and deformed passageway 240A′, following simulated yield.

FIG. 5 is a graph of flight time as a function of payload for exemplary embodiments and for a comparative example. In this example, the vehicle is a hexicopter UAV, as described with respect to Table 1. The comparative example is powered by a Li-ion polymer 6S16P (2.5 Ah/cell) system, as described with respect to Table 2. As the hydrogen storage density is increased, longer flight times and higher payloads may be achieved compared with the comparative example.

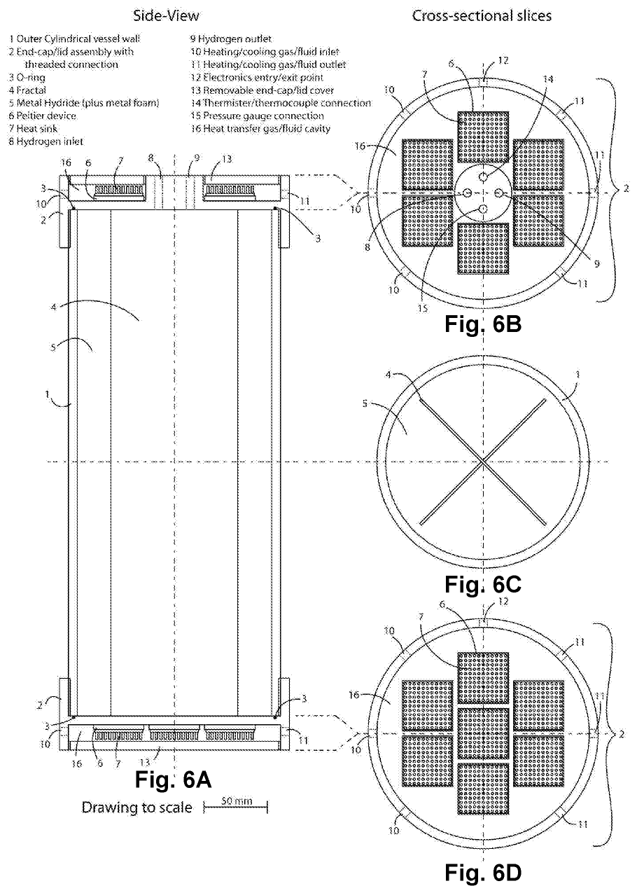

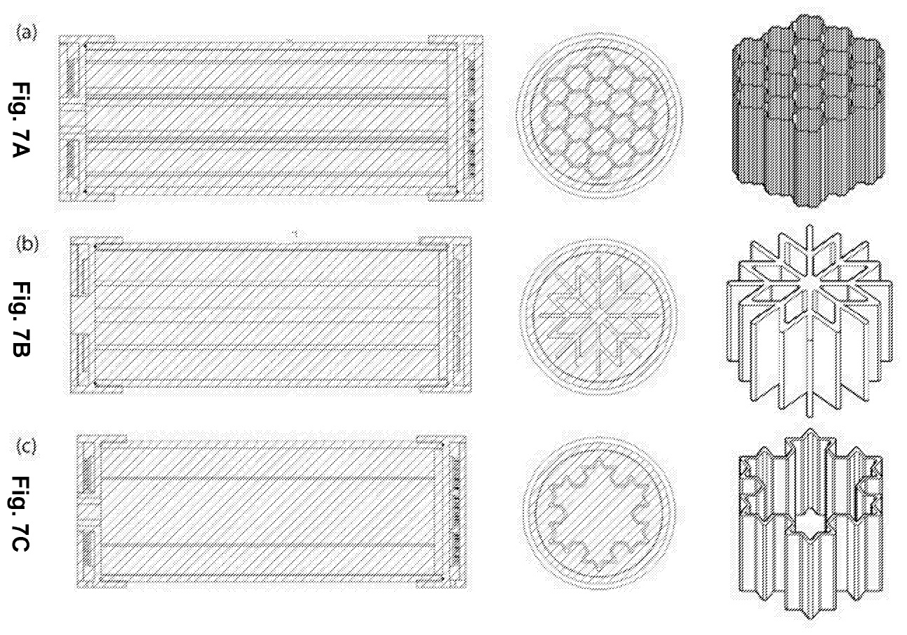

FIG. 6A is a schematic axial cross-section of a hydrogen storage device 200 for a power supply 100 according to an exemplary embodiment and FIGS. 6B to 6D are schematic transverse cross-sections of the hydrogen storage device 200 of FIG. 6A.

FIG. 6 shows a hydrogen storage device 200 for the power supply 100. The hydrogen storage device 200 comprises a hollow metal cylinder (outer cylindrical vessel wall (1)) and along with two metallic end-caps (2), providing the pressure vessel. Inside this volume exists the hydrideable metal/metal alloy (5), an aluminium fractal structure (4) with metallic foam in contact with it (not shown in figure). Both end-caps (2) contain an internal cavity for the location of multiple peltier devices (6) and heat/cold sinks (7). In the outer cylindrical vessel wall (1), there are three gas inlets (10) and three gas outlets (11) allow for heating/cooling gas (air) access to this internal cap cavity to add/remove heat. There is also an electronic entry/exit point (12) in the outer cylindrical vessel wall (1). In one of the end-caps four ports (holes) are included, allowing access into the pressure vessel; they are a hydrogen gas inlet (8), a hydrogen gas outlet (9), a pressure sensor connection (15) and a temperature sensor connection (14). The end-caps are held in place and form a seal through a thread and o-ring arrangement (3). The end-caps can be removed for easy access to the pressure vessel. The end-caps have covers (13) which can be removed for easy access to the heating/cooling gas containment volume within them. That is, the hydrogen storage device 200 comprises the pressure vessel 1, having the first fluid inlet 8 and the first fluid outlet 9, comprising therein a thermally conducting network 4 optionally thermally coupled to the first heater (not shown), wherein the pressure vessel 1 is arranged to receive therein a hydrogen storage material (not shown) in thermal contact, at least in part, with the thermally conducting network 4, wherein the first fluid inlet 8 and/or the first fluid outlet 9 are in fluid communication with the first releasable fluid inlet coupling (not shown) and/or the first releasable fluid outlet coupling (not shown), respectively; and preferably, wherein the thermally conducting network 4 has a lattice geometry, a gyroidal geometry and/or a fractal geometry in two and/or three dimensions.

FIGS. 7A to 7C schematically depict thermally conducting networks for a hydrogen storage device for a power supply according to an exemplary embodiment.

FIG. 7 shows there are shown three alternative fractal networks (A) Gosper Island; (B) ‘Snowflake’ design; and (C) Koch Snowflake for the thermally conducting network of the hydrogen storage device 200. The 2D radially symmetric fractal patterns extend axially. Axial cross-sections, midpoint radial cross-sections and perspective views for the fractal networks are shown.

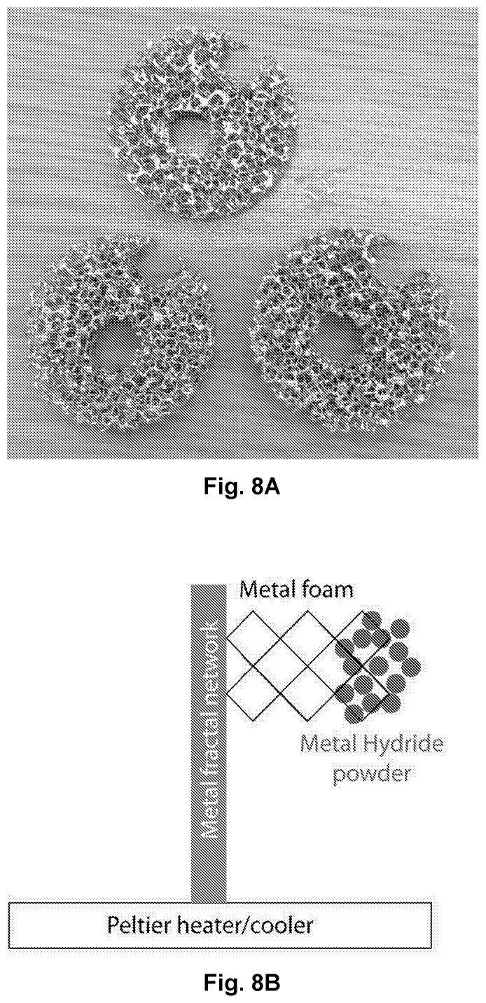

FIG. 8A is a photograph of a foam for a hydrogen storage device for a power supply according to an exemplary embodiment; and FIG. 8B is a schematic view of a hydrogen storage device for a power supply according to an exemplary embodiment, in more detail.

FIG. 8A shows a photograph of voids (i.e. open space) in a metal foam, particularly aluminium foam. The aluminium foam is produced from 6101 aluminium alloy, retaining 99% purity of the parent alloy. The foam has a reticulated structure in which cells (i.e. pores) are open and have a dodecahedral shape. The foam has a bulk density of 0.2 g/cm3; a porosity of 93% porosity and about 8 pores/cm.

FIG. 8B schematically depicts a metal hydride powder included and/or in contact with a metal foam which in turn is thermally coupled to a thermally conducting network.

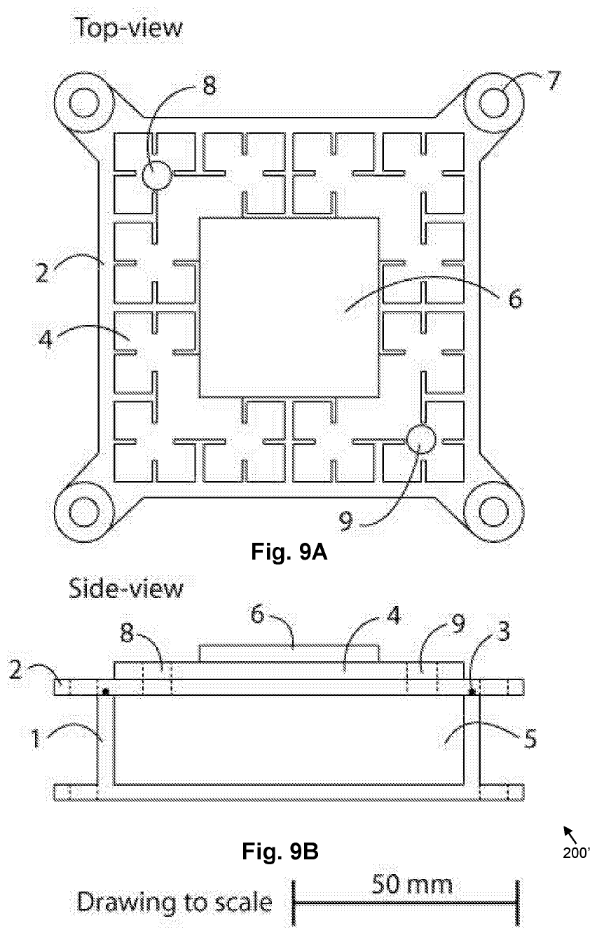

FIG. 9A is a plan elevation view of a hydrogen storage device 200′ fora power supply according to an exemplary embodiment and FIG. 9B is a side cross-sectional view of the hydrogen storage device 200′ of FIG. 9A.

FIGS. 9A and 9B schematically depict a compact design of a hydrogen storage device 200′. The hydrogen storage device 200′ comprises a hydrogen gas containment volume formed from a cuboid-based container vessel (1) with square-planar lid (2). The lid (2) is secured through the use of four axial-corner screws in screw fixings (7) and it is sealed by an O-ring (3) positioned between the vessel (1) and the lid (2). The hydrogen containment volume has within it a hydrideable metal/metal alloy (5) and metal foam (not shown). On one surface there is a thermally conducting network (4) having a flat square-based fractal geometry, that acts to dissipate heat radially. A Peltier device (6), thermally coupled to the thermally conducting network (4) and outside of the vessel (1) acts as a heater/cooler. Two holes (8) and (9) located through the lid (2) and the thermally conducting network (4) act as a hydrogen gas inlet (8) and outlet (9), respectively. That is, the hydrogen storage device 200′ comprises the pressure vessel 1, having the first fluid inlet 8 and the first fluid outlet 9, comprising therein a thermally conducting network 4 optionally thermally coupled to the first heater (not shown), wherein the pressure vessel 1 is arranged to receive therein a hydrogen storage material (not shown) in thermal contact, at least in part, with the thermally conducting network 4, wherein the first fluid inlet 8 and/or the first fluid outlet 9 are in fluid communication with the first releasable fluid inlet coupling (not shown) and/or the first releasable fluid outlet coupling (not shown), respectively; and preferably, wherein the thermally conducting network 4 has a lattice geometry, a gyroidal geometry and/or a fractal geometry in two and/or three dimensions.

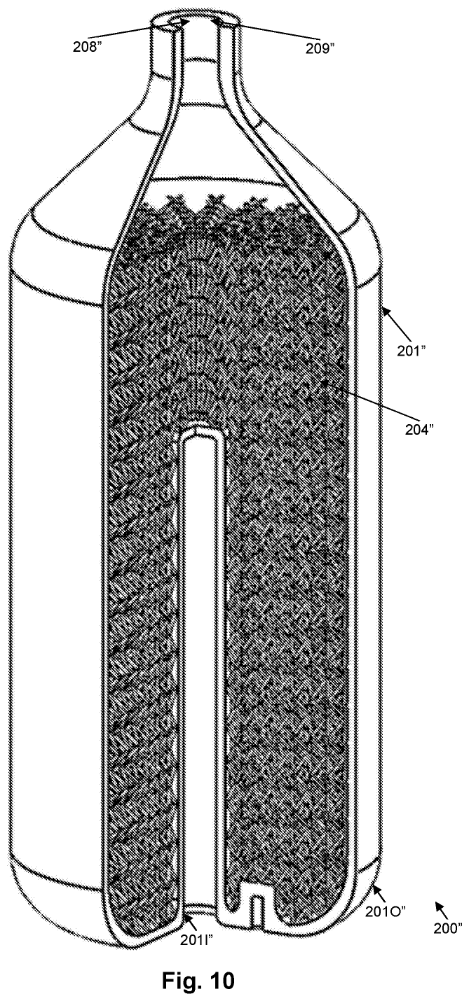

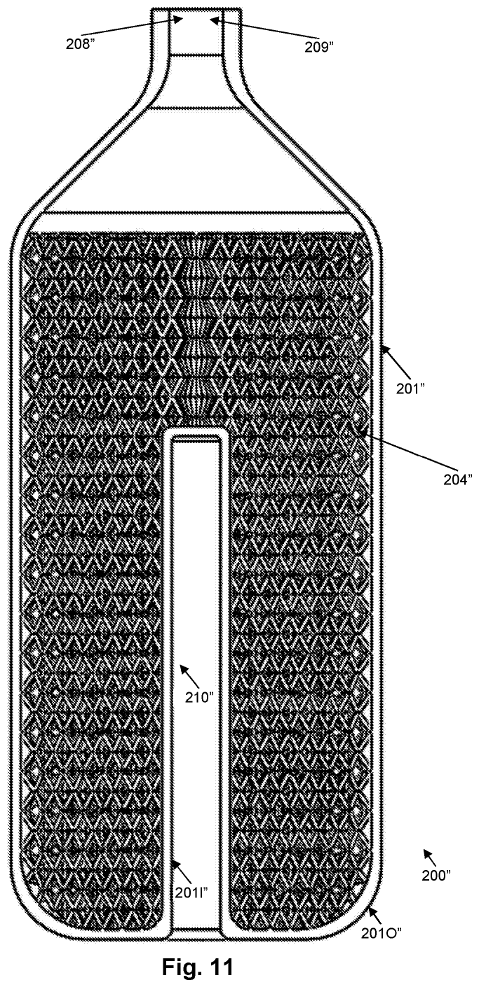

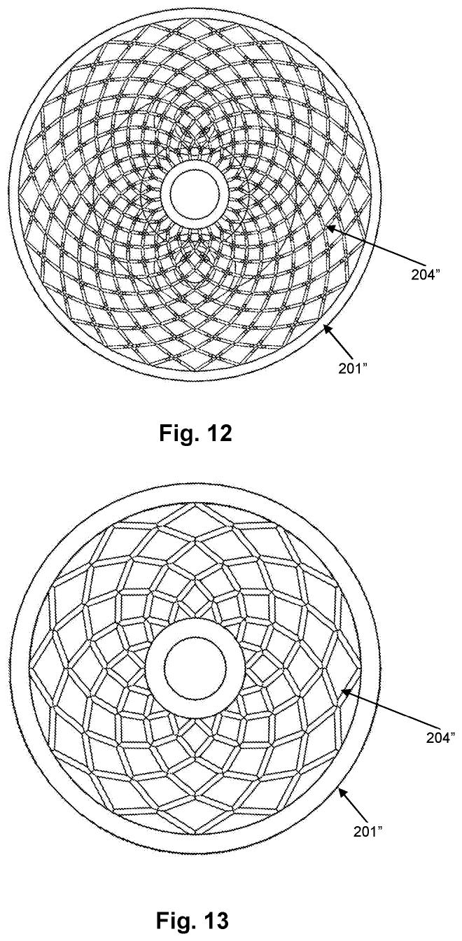

FIG. 10 is CAD cutaway perspective view of a hydrogen storage device 200″ for a power supply according to an exemplary embodiment. FIG. 11 is CAD axial cross-section of the hydrogen storage device 200″ of FIG. 10. FIG. 12 is a CAD radial cross-section of the hydrogen storage device 200″ of FIG. 10. The hydrogen storage device 200″ comprises a pressure vessel 201″, having a first fluid inlet 208″ and a first fluid outlet 209″, comprising therein a thermally conducting network 204″ optionally thermally coupled to the first heater (not shown), wherein the pressure vessel 201″ is arranged to receive therein a hydrogen storage material (not shown) in thermal contact, at least in part, with the thermally conducting network 204″, wherein the first fluid inlet 208″ and/or the first fluid outlet 209″ are in fluid communication with the first releasable fluid inlet coupling (not shown) and/or the first releasable fluid outlet coupling (not shown), respectively; and preferably, wherein the thermally conducting network 204″ has a lattice geometry, a gyroidal geometry and/or a fractal geometry in two and/or three dimensions.

In this example, the pressure vessel 201″ is generally cylindrical, having a generally dished first end and a necked second end opposed thereto, and having a single aperture providing both the first fluid inlet 208″ and the first fluid outlet 209″. In other words, the pressure vessel 201″ is bottle-shaped. An inner wall portion 2011″ of the pressure vessel 201″ provides an axial cylindrical, elongate blind passageway 210″, arranged to receive a first heater 206″ (not shown), that extends from the first end towards the second end and that is coaxial with an outer wall portion 2010″ of the pressure vessel 201″. A second blind passageway in the first end is arranged to receive a thermocouple (not shown).

In this example, the pressure vessel has an internal volume of about 500 cm³, thereby providing a hydrogen storage capacity of about 25 g Hz. In this example.

In this example, the thermally conducting network 204″ has a lattice geometry in three dimensions. In this example, an effective density of the lattice geometry is uniform in a first dimension, particularly axially, and non-uniform in mutually orthogonal second and third dimensions, particularly radially. Particularly, the effective density decreases radially outwards, such that there is faster heat transfer proximal the passageway 210″ and hence the first heater. In this example, the thermally conducting network 204″ is formed from an aluminium alloy. Alternatively, the thermally conducting network 204″ may be formed from copper, respective alloys thereof such as brass or bronze alloys, and/or stainless steel, as described previously.

FIG. 13 is an alternative CAD radial cross-section for the hydrogen storage device 200″ of FIG. 10. In this example, a node density (i.e. number of nodes per unit volume) of the lattice geometry, generally otherwise similar to the lattice geometry of FIG. 12 mutatis mutandis, is relatively lower than that of the lattice geometry of FIG. 12. A cross-sectional area of the arms is relatively larger than that of FIG. 12.

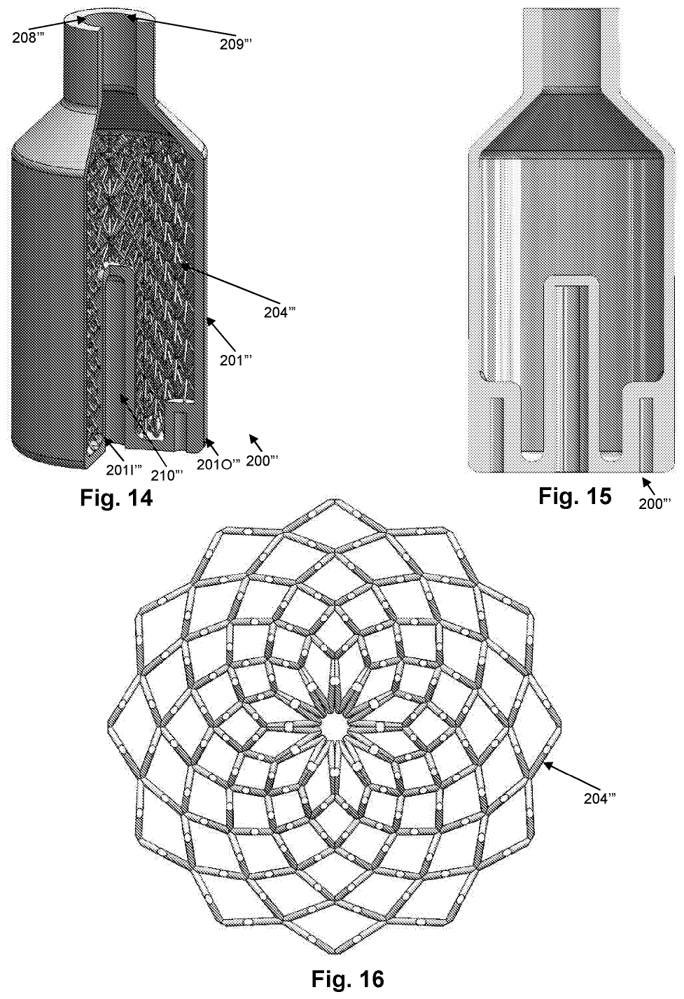

FIG. 14 is a CAD cutaway perspective view of a hydrogen storage device 200′″ for a vehicle according to an exemplary embodiment. FIG. 15 is a CAD axial cross-section of the hydrogen storage device 200′″ of FIG. 14. In this example, the pressure vessel 201′″ has an internal volume of about 50 cm³, thereby providing a hydrogen storage capacity of about 2.5 g H₂.

FIG. 16 is a CAD radial cross-section of a thermally conducting network of the hydrogen storage device of FIG. 14. Generally, the lattice geometry is as described with respect to FIG. 13.

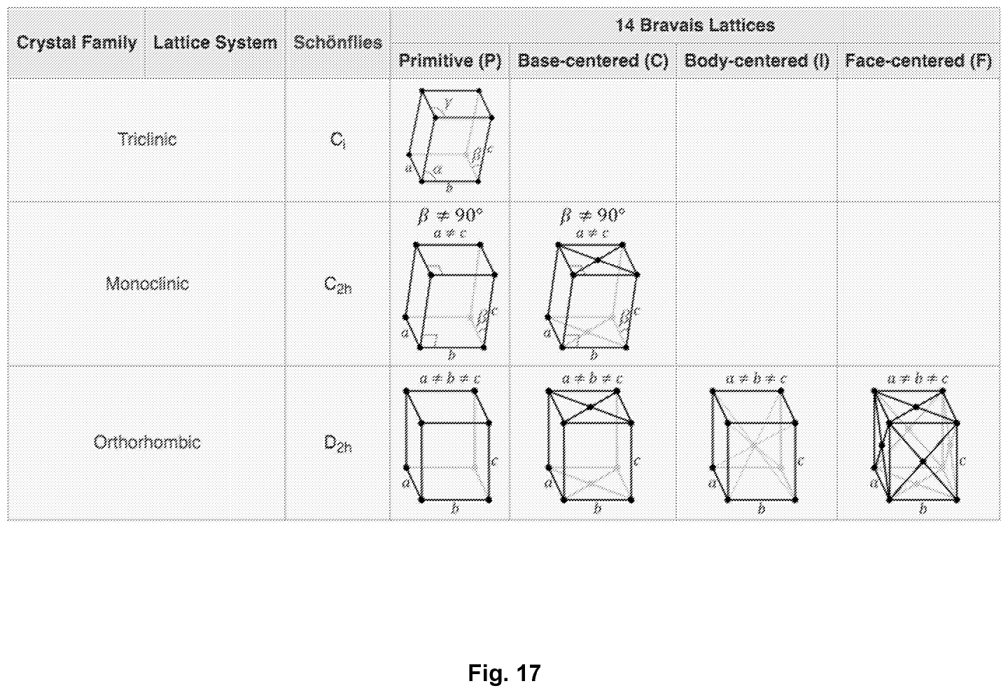

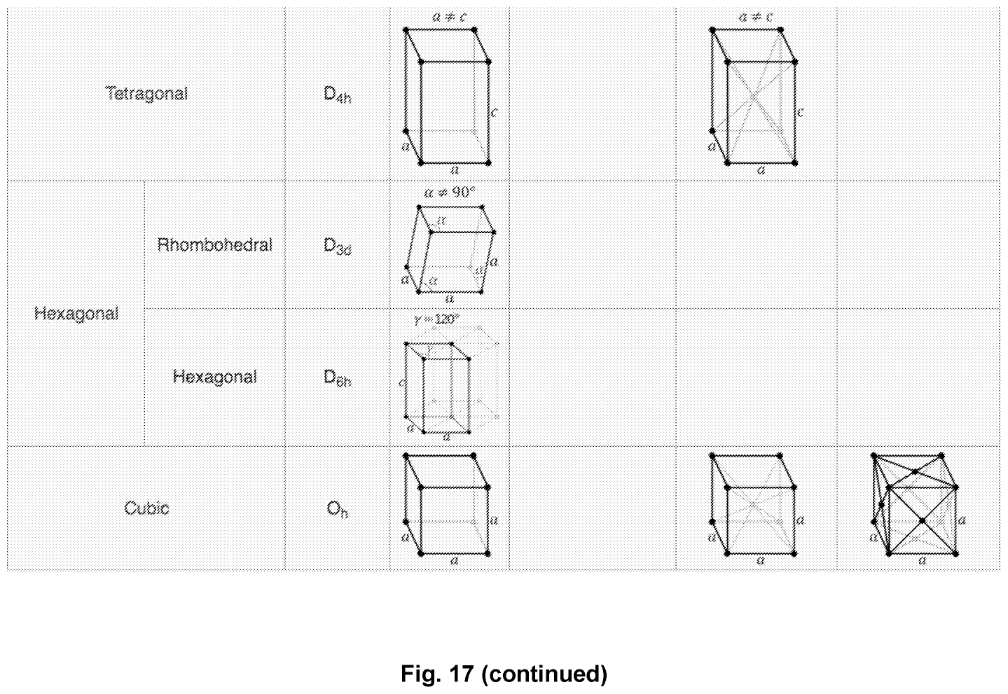

FIG. 17 schematically depicts Bravais lattices for a thermally conducting network, as described above.

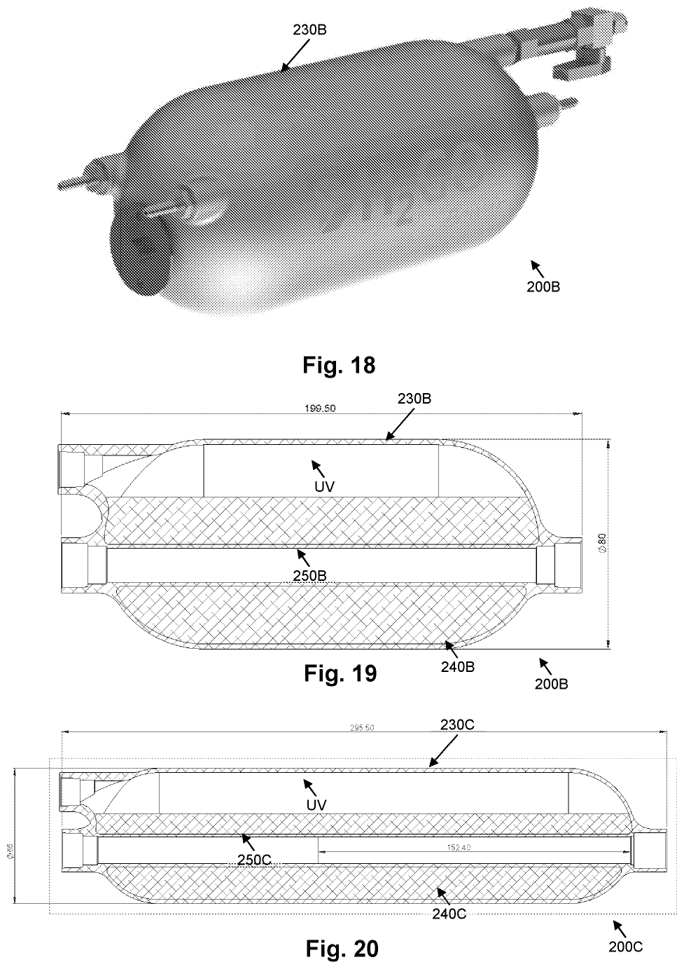

FIG. 18 is a CAD perspective view of a hydrogen storage device 200B for a vehicle according to an exemplary embodiment, generally as described with respect to the hydrogen storage device 200A. FIG. 19 is a CAD axial cross-section of the hydrogen storage device 200B of FIG. 18. In this example, the hydrogen storage device 200B is arranged to be oriented horizontally, in use. In this example, the pressure vessel 230B is generally cylindrical, having dished ends. In this example, a passageway 250B, provided by a tube having a circular cross-section, extends between the dished ends longitudinally, offset from an axis of the pressure vessel 230A. In this example, the thermally conducting network 240B partially fills an internal volume of the pressure vessel, particularly a region of the internal volume extending across about 75% of a diameter the pressure vessel, thereby completely surrounding the tube, such that an unfilled volume above the thermally conducting network 240B is defined. In this example, the thermally conducting network 240B is thermally coupled to at least a part of an internal surface of the pressure vessel 230B and an external surface of the tube. In this example, the unfilled volume acts as a buffer, providing a reservoir of hydrogen during charging and similarly during release, for example to account for kinetics thereof.

FIG. 20 is a CAD axial cross-section of a hydrogen storage device 240C for a vehicle according to an exemplary embodiment, generally as described with respect to FIGS. 18 and 19, having a relatively longer axial length and a relatively smaller diameter.

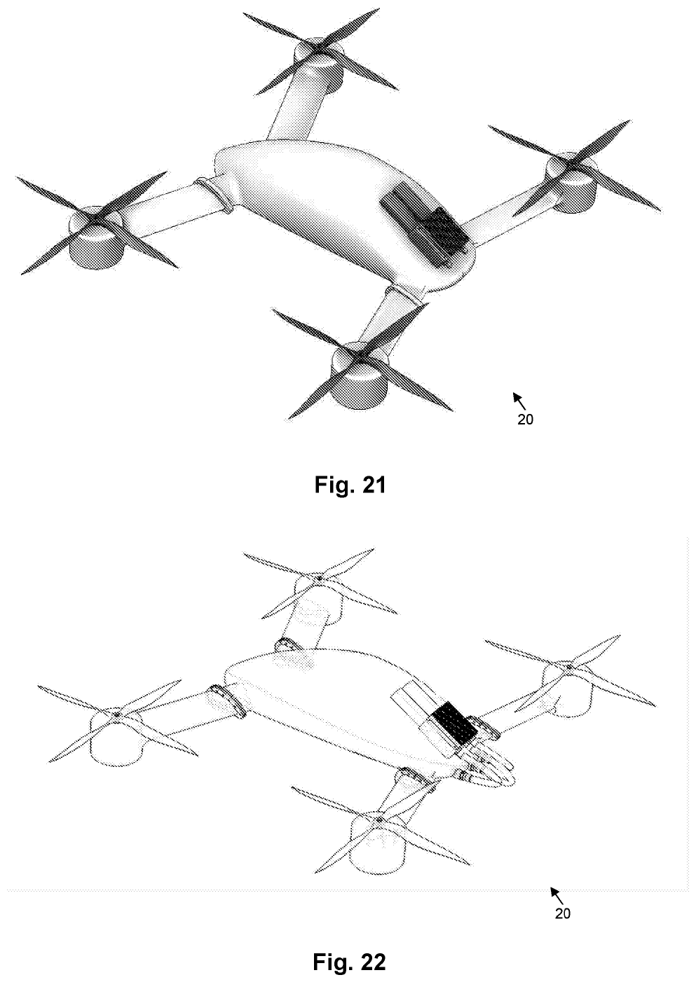

FIG. 21 is a CAD perspective view of a vehicle 20 according to an exemplary embodiment, generally as described with respect to the vehicle 10. FIG. 22 is a CAD perspective view of the vehicle 20 of FIG. 21, in more detail. In this example, the vehicle 20 is a quad copter UAV. In this example, the propulsion system is releasably coupled, using mechanical fasteners, to the first hydrogen storage device. In this example, the first hydrogen storage device has at most two planes of symmetry, particularly having a shape arranged to reduce drag (i.e. shaped aerodynamically), in use. In this example, a fuel cell and a controller are releasably coupled, using mechanical fasteners, to the first hydrogen storage device, particularly to an external surface thereof.

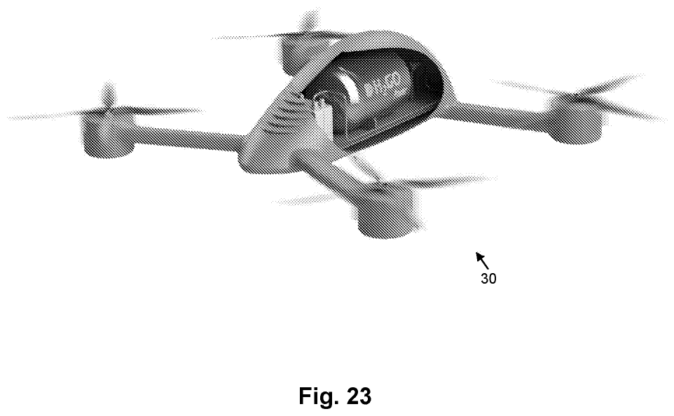

FIG. 23 is a CAD cutaway perspective view of a vehicle 30 according to an exemplary embodiment, generally as described with respect to the vehicle 10. In this example, the vehicle 30 is a quad copter UAV. In this example, the pressure vessel comprises a double wall (i.e. an inner pressure wall and an outer wall). In this example, the outer wall is shaped aerodynamically. In this example, the inner wall is cylindrical, having dished ends. In this example, one or more components, particularly a fuel cell and a controller, of the vehicle 30 are arranged in the gap within the double wall.

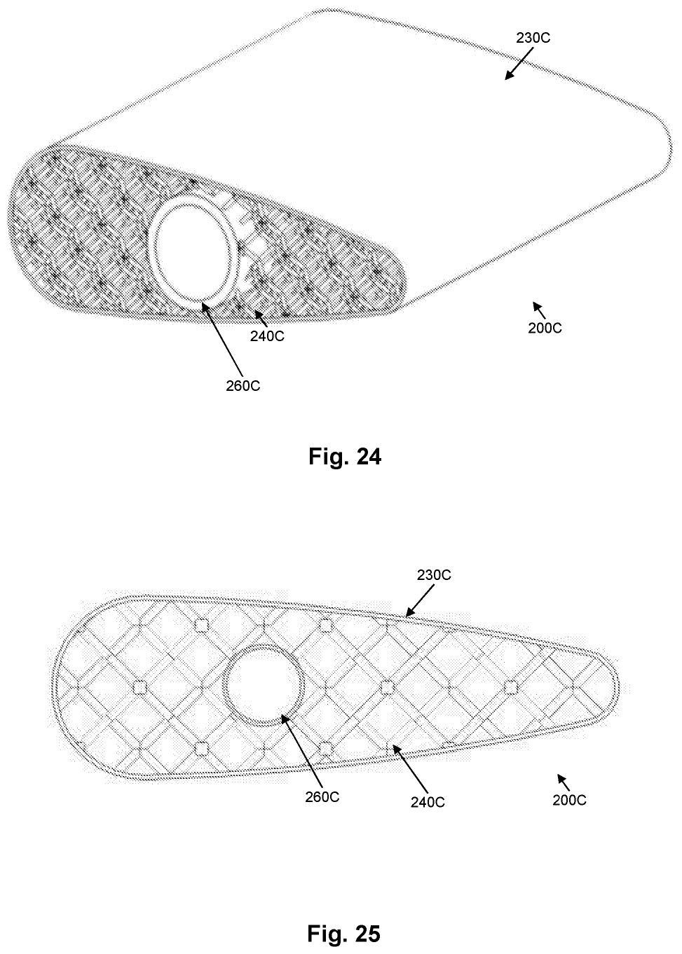

FIG. 24 is a CAD perspective cross-section view of hydrogen storage device 200C for a vehicle according to an exemplary embodiment. FIG. 25 is a CAD cross-section view of the hydrogen storage device 200C of FIG. 24.

In this example, the hydrogen storage device 200C provides a first structural component 100C, particularly a fixed wing, of the set of structural components 100 of the vehicle, wherein the vehicle is a fixed wing aircraft. In this example, a wall of the pressure vessel 230C of the hydrogen storage device 200C provides an aerofoil, thereby defining upper, lower, leading and trailing edges, of the fixed wing. In this example, the pressure vessel 230C comprises a tube 260C having a circular cross-section, arranged to receive a first heater therein, providing a wing spar. In this example, the thermally conducting network 240C has a lattice geometry in three-dimensions. In this example, the thermally conducting network is formed, at least in part, by 3D printing. In this example, the thermally conducting network 240C is thermally coupled to an external surface of the vehicle by being thermally coupled to an internal surface of the pressure vessel. In this example, the thermally conducting network 240C is thermally coupled to the tube 260C. In this example, the lattice geometry is a body-centred cubic lattice.

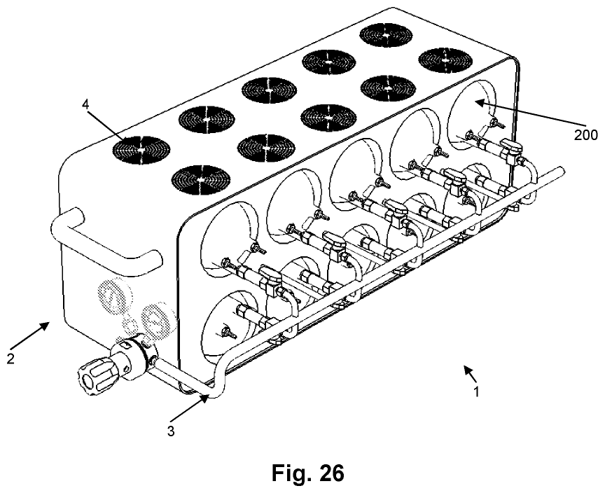

FIG. 26 is a CAD perspective view of a charging station assembly 1 according to an exemplary embodiment. The charging station assembly 1 comprises a charging station 2 and a hydrogen storage device 200. In this example, the charging station 2 is arranged to receive eight hydrogen storage devices, arranged in a bank of 4×2 hydrogen storage devices. In this example, the charging station 2 is arranged to charge a plurality of hydrogen storage devices 200, for example simultaneously. In this example, the charging station 2 comprises a manifold 3 coupleable to the plurality of hydrogen storage devices 200. In this example, the charging station 2 comprises a cooling system 4, arranged to cool a hydrogen storage device during charging thereof. In this example, the cooling system 2 comprises a plurality of fans.

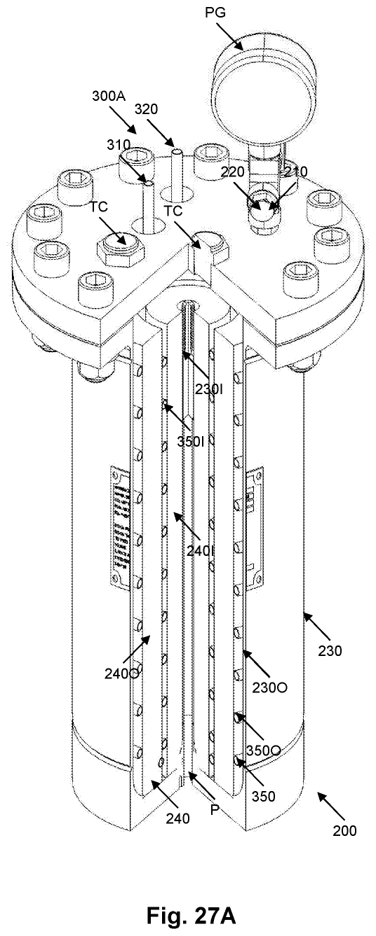

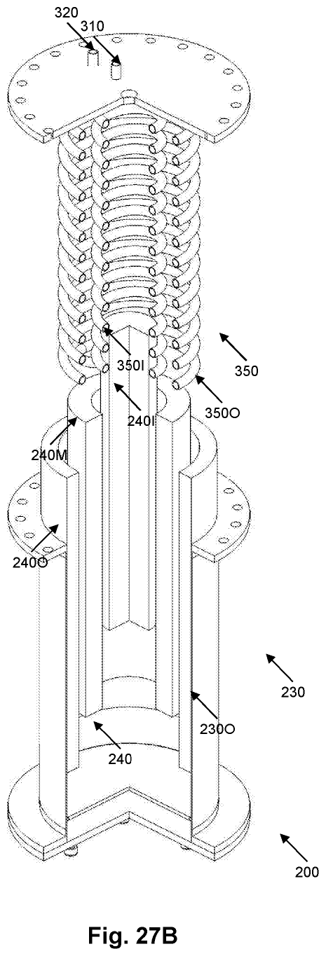

FIG. 27A is a cutaway perspective view of a hydrogen storage device 200 for a vehicle according to an exemplary embodiment. The hydrogen storage device 200 comprises a pressure vessel 230, having a first fluid inlet 210 and a first fluid outlet 220, comprising therein a thermally conducting network 240 thermally coupled to a first heater 300A, wherein the pressure vessel 230 is arranged to receive therein a hydrogen storage material (not shown) in thermal contact, at least in part, with the thermally conducting network 240, wherein the first fluid inlet 210 and/or the first fluid outlet 220 are in fluid communication with the first releasable fluid inlet coupling (not shown) and/or the first releasable fluid outlet coupling (not shown), respectively; and wherein the thermally conducting network 240 has a lattice geometry in three dimensions.

In this example, the pressure vessel 230 is generally cylindrical, having a generally internally dished first end and a flanged second end opposed thereto, and having a single aperture providing both the first fluid inlet 210 and the first fluid outlet 220. In other words, the pressure vessel 230 is can-shaped. An inner wall portion 2301 of the pressure vessel 230 provides an axial cylindrical, elongate blind passageway P, arranged to optionally receive a second heater 300B (not shown) of the set of heaters 300, particularly a cartridge heater (not shown), that extends from the first end towards the second end and that is coaxial with an outer wall portion 2300 of the pressure vessel 230. Blind passageways in the second end are arranged to receive thermocouples TC. In this example, the first heater 300A is provided by a recirculating heater, for example heated using waste heat from a fuel cell coupled thereto, and includes a double helix heating tube 350, having an inlet 310 and an outlet 320, in thermal contact with the thermally conducting network 20, which is arranged between the inner 3501 and outer 3500 helices of the heating tube 350. The double helix heating tube 350 extends from the second end towards the first end is coaxial with an outer wall portion 2300 of the pressure vessel 230. The inner 3501 and outer 3500 helices of the double helix heating tube 350 are directly in thermal contact with the inner wall portion 2301 and the outer wall portion 2300 of the pressure vessel 230, respectively. A pressure gauge PG is provided in the second end. The second end is mechanically releasably coupled to the pressure vessel 230, using mechanical fasteners.

In this example, the thermally conducting network 240 has a lattice geometry in three dimensions, in which generally each node is connected by four arms to four other nodes, respectively, in an axially adjacent preceding layer, such that generally each node is thus connected by eight arms to eight other nodes, four nodes in the axially adjacent preceding layer and four nodes in an axially adjacent proceeding layer. Nodes proximal the inner 3501 and outer 3500 helices of the heating tube 350 are in mutual thermal contact therewith. In this example, an effective density of the lattice geometry is uniform in a first dimension, particularly axially, and non-uniform in mutually orthogonal second and third dimensions, particularly radially. In this example, the thermally conducting network 240 has a porosity of at least 90%. In this example, the thermally conducting network 240 is formed from an aluminium alloy. In this example, the thermally conducting network 240 comprises inner 2401 and outer 2400 portions, having annular shapes. The outer portion 2400 is received in thermal contact with and between the inner 3501 and outer 3500 helices of the double helix heating tube 350 while the inner portion 2401 is received in thermal contact with and within the inner helix 3501.

FIG. 27B is a cutaway perspective exploded view of a related hydrogen storage device 200. In contrast with the hydrogen storage device 200 of FIG. 27A, the thermally conducting network 240 of the hydrogen storage device 200 of FIG. 27B comprises inner 2401, middle 240M and outer 2400 portions. The inner portion 2401 has a cylindrical shape and the middle 240M and outer 2400 portions have annular shapes. The outer portion 2400 is received in thermal contact and without the outer 3500 helices of the double helix heating tube 350, the middle portion 240M is received in thermal contact with and between the inner 3501 and outer 3500 helices while the inner portion 2401 is received in thermal contact with and within the inner helix 3501.

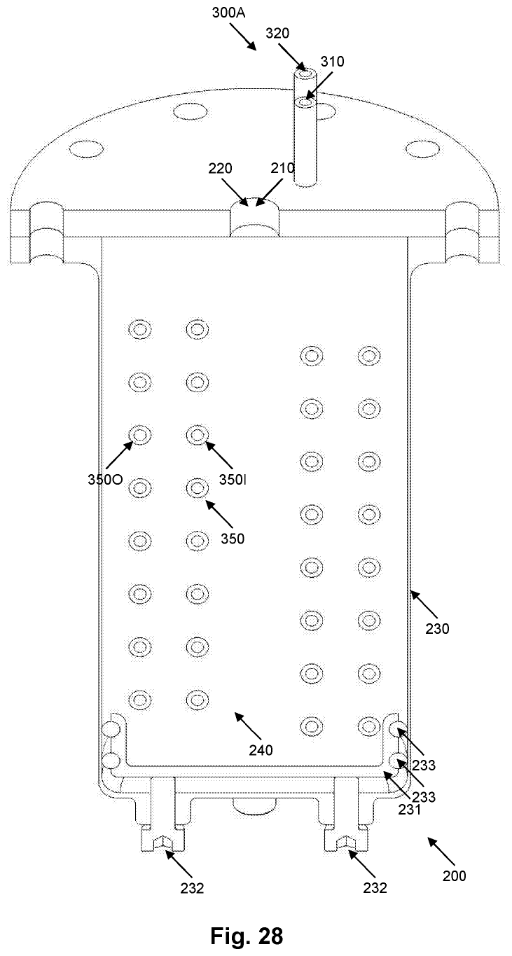

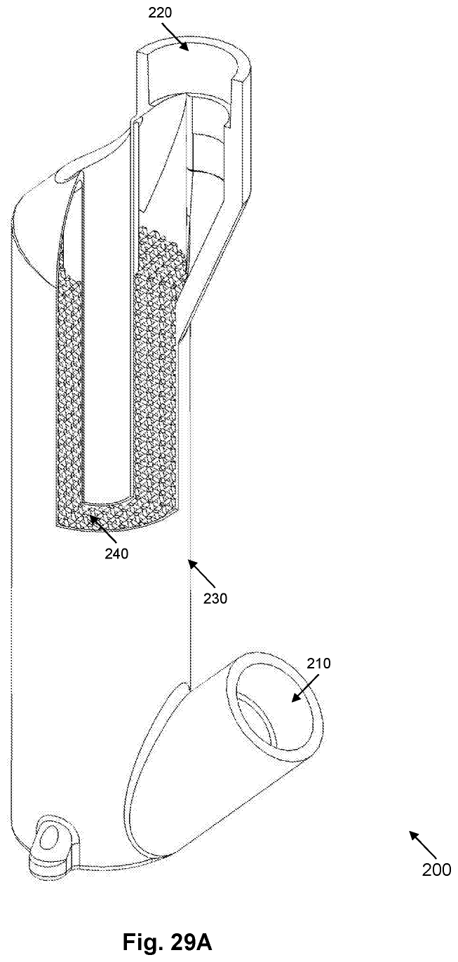

FIG. 28 is a cutaway perspective view of a hydrogen storage device for a vehicle according to an exemplary embodiment. The hydrogen storage device 200 is generally as described with respect to the hydrogen storage devices 200 of FIGS. 27A and 27B and like reference signs denote like features.

In contrast with the hydrogen storage device 200 of FIGS. 27A and 27B, the hydrogen storage device 200 does not include the inner wall portion 2301 of the pressure vessel 230 of FIGS. 27A and 27B and does not include blind passageways in the second end to receive thermocouples. In contrast with the hydrogen storage device 200 of FIGS. 27A and 27B, the thermally conducting network 240 is cylindrical, to be received in thermal contact with the outer wall portion 2300 of the pressure vessel 230. In contrast with the hydrogen storage device 200 of FIGS. 27A and 27B, the inner 3501 and outer 3500 helices of the double helix heating tube 350 are integrated within the thermally conducting network 240. Hence, the inner 3501 and outer 3500 helices of the double helix heating tube 350 are mutually spaced apart from and only indirectly in thermal contact with the outer wall portion 2300 of the pressure vessel 230, respectively, via the thermally conducting network 240. In this example, the hydrogen storage device 200 includes a bed compression disc 231, internal to the pressure vessel 230 proximal the first end and bed compression disc bolts 232 mechanically coupled thereto, extending through the first end, for uniaxially compressing the hydrogen storage material to improve thermal contact with the thermally conducting network. O-rings 233 are arranged in the outer wall portion 2300 to prevent loss of the hydrogen storage material during compression thereof.

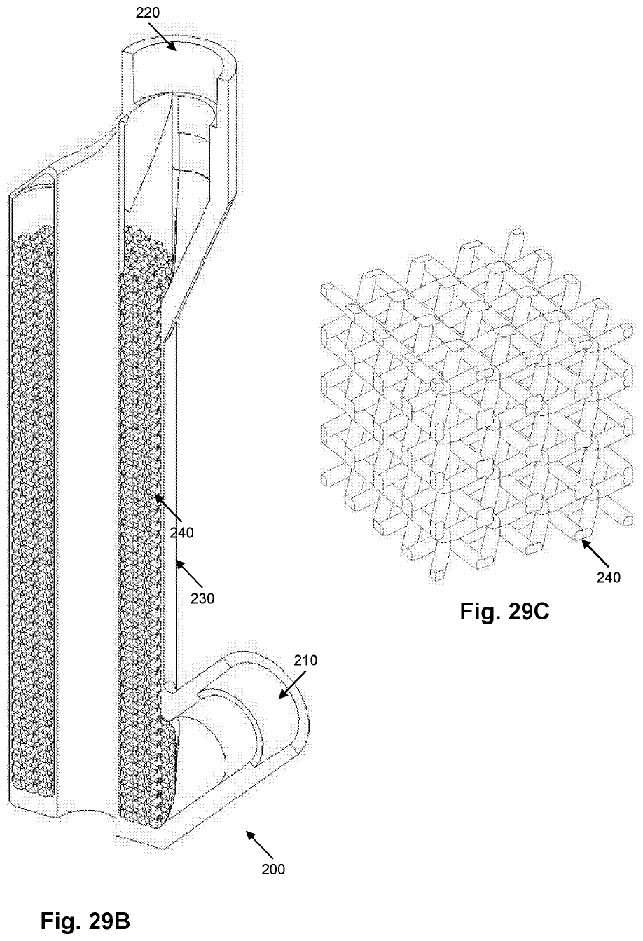

FIG. 29A is a CAD partial cutaway perspective view of a hydrogen storage device 200 for a vehicle according to an exemplary embodiment; FIG. 29B is a CAD longitudinal perspective cross-sectional view of the hydrogen storage device 200; and FIG. 29C is a CAD perspective view of the thermally conducting network, in more detail.

The hydrogen storage device 200 comprises a pressure vessel 230, having a first fluid inlet 210 and a first fluid outlet 220, comprising therein a thermally conducting network 240 thermally coupled to a first heater 300A, wherein the pressure vessel 230 is arranged to receive therein a hydrogen storage material (not shown) in thermal contact, at least in part, with the thermally conducting network 240, wherein the first fluid inlet 210 and/or the first fluid outlet 220 are in fluid communication with the first releasable fluid inlet coupling (not shown) and/or the first releasable fluid outlet coupling (not shown), respectively; and wherein the thermally conducting network 240 has a lattice geometry in three dimensions. In this example, the hydrogen storage material comprises and/or is a liquid organic hydrogen carrier, LOHC. In this example, the hydrogen storage device 200 is a dynamic hydrogen storage device 200. In this example, the first fluid inlet 210 and the first fluid outlet 220 are mutually spaced apart at opposed ends of the first vessel 230, thereby defining, at least in part, a path for flow of the hydrogen storage material and/or hydrogen therebetween, for example via the voids of the thermally conducting network 240. In this example, the first fluid inlet 210 and the first fluid outlet 220 comprise releasable couplings, thereby providing coupling thereto and uncoupling therefrom, for example repeatedly, of corresponding couplings. In this example, the lattice geometry is Bravais lattice particularly a cubic lattice specifically a primitive cubic lattice. In this example, the thermally conducting arms have a cross sectional dimension (for example a diameter or a width) of about 0.5 mm. In this example, the thermally conducting network 240 partially fills an internal volume of the first vessel 230, of at least 90%, by volume of the first vessel 230. In this example, the thermally conducting network 240 comprises a LOHC hydrogenation and/or dehydrogenation catalyst, for example provided on and/or in a surface thereof. In this example, the thermally conducting network 240 has a porosity in a range from 75% to 95%, by volume of the thermally conducting network 240. In this example, the thermally conducting network 240 has a specific surface area in a range from 1 m⁻¹ to 10 m⁻¹, particularly about 7 m⁻¹. In this example, the thermally conducting network 240 comprises a LOHC hydrogenation and/or dehydrogenation catalyst, for example provided on and/or in a surface thereof. In this example, the first heater is arranged heat the hydrogen storage material to temperature in a range from 150° C. to 300° C. In this example, the hydrogen storage device 200 comprises a pump (not shown) arranged to flow the hydrogen storage material through the first vessel 230. In this example, the hydrogen storage device 200 is a reactor.

Generally, the first vessel 230 is an elongated cylinder formed from a Ti alloy (to withstand an operating pressure of about 2 bar at a temperature of about 260° C. for dehydrogenation), having a bore extending therethrough for the first heater, particularly a Joule cartridge heater. The first fluid inlet 210 and the first fluid outlet 220 are provided with Swagelok releasable couplings. The first fluid inlet 210 is arranged at an acute angle to the axis of the first vessel and the first fluid outlet is arranged parallel to the axis, to suit the particular application.

### Alternatives

Although a preferred embodiment has been shown and described, it will be appreciated by those skilled in the art that various changes and modifications might be made without departing from the scope of the invention, as defined in the appended claims and as described above.

### SUMMARY

In summary, a vehicle, preferably an unmanned and/or autonomous vehicle for example an unmanned aerial vehicle, UAV, is described. The vehicle comprises: a set of structural components, arranged to provide, at least in part, a structure of the vehicle and to resist, at least in part, internal and external forces in one, two or three dimensions; a propulsion system, arranged to propel the vehicle, and/or an auxiliary power supply, arranged to provide electrical power to the vehicle; a set of hydrogen storage devices, including a first hydrogen storage device, and optionally a set of heaters including a first heater, wherein the set of hydrogen storage devices is arranged to provide hydrogen gas to the propulsion system and/or to the auxiliary power supply; wherein the first hydrogen storage device comprises: a pressure vessel, having a first fluid inlet and a first fluid outlet, comprising therein a thermally conducting network optionally thermally coupled to the first heater, wherein the pressure vessel is arranged to receive therein a hydrogen storage material in thermal contact, at least in part, with the thermally conducting network; and preferably, wherein the thermally conducting network has a lattice geometry, a gyroidal geometry and/or a fractal geometry in two and/or three dimensions; and wherein the first hydrogen storage device, preferably the pressure vessel and/or the thermally conducting network thereof, provides a first structural component of the set of structural components. By storing the hydrogen using the hydrogen storage material in the pressure vessel of the hydrogen storage device, a hydrogen storage capacity is improved while a storage pressure is reduced, compared with conventional storage of hydrogen, thereby enhancing safety while increasing a range and/or a payload and/or decreasing a fuel consumption of the vehicle. Since the hydrogen storage device provides the first structural component, a structural integrity of the vehicle is improved while a mass of the vehicle is reduced, thereby increasing a range and/or a payload and/or decreasing a fuel consumption of the vehicle.

### DISCLOSURE

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A vehicle comprising:
a set of structural components, arranged to provide, at least in part, a structure of the vehicle and to resist, at least in part, internal and/or external forces in one, two or three dimensions;
a propulsion system, arranged to propel the vehicle, and/or an auxiliary power supply, arranged to provide electrical power to the vehicle;
a set of hydrogen storage devices, including a first hydrogen storage device, and a set of heaters including a first heater, wherein the set of hydrogen storage devices is arranged to provide hydrogen gas to the propulsion system and/or to the auxiliary power supply;
wherein the first hydrogen storage device comprises:
a pressure vessel, having a first fluid inlet and a first fluid outlet, comprising therein a thermally conducting network thermally coupled to the first heater, wherein the pressure vessel is arranged to receive therein a hydrogen storage material in thermal contact, at least in part, with the thermally conducting network; and wherein the thermally conducting network has a lattice geometry, a gyroidal geometry and/or a fractal geometry in two and/or three dimensions; and
wherein the first hydrogen storage device, preferably the pressure vessel and/or the thermally conducting network thereof, provides a first structural component of the set of structural components.

2. The vehicle according to claim 1, wherein the propulsion system and/or the auxiliary power supply comprises:
a set of electrical generators, including a first electrical generator, configured to generate electricity using the hydrogen gas, selected from a group comprising a fuel cell and an electrical generator comprising a heat engine.

3. The vehicle according to claim 2, wherein the first electrical generator is the fuel cell, selected from a group comprising a proton exchange membrane fuel cell, PEMFC, an alkaline fuel cell, AFC, and a phosphoric acid fuel cell, PAFC.

4. The vehicle according to claim 1, wherein the vehicle is an aircraft, and wherein the first structural component defines an airframe, a fuselage, a fixed wing and/or a part thereof.

5. The vehicle according to claim 1, wherein the vehicle is a watercraft, such as a surface watercraft or a submersible watercraft, and wherein the first structural component defines a hull or part thereof.

6. The vehicle according to claim 1, wherein the vehicle is a land craft and wherein the first structural component defines a chassis or part thereof.

7. The vehicle according to claim 1, wherein the thermally conducting network is thermally coupleable to an external surface of the vehicle.

8. The vehicle according to claim 1, wherein the thermally conducting network is thermally coupleable to the propulsion system and/or to the auxiliary power supply.

9. The vehicle according to claim 1, comprising:
a controller configured to control the first heater based, at least in part, on a power output of the propulsion system and/or of the auxiliary power supply.

10. The vehicle according to claim 9, wherein:
the controller is configured to control the first heater based, at least in part, on a predicted rate of power output of the propulsion system and/or of the auxiliary power supply.

11. The vehicle according to claim 1, wherein the first hydrogen storage device has a hydrogen storage density of at least 0.01 wt. % of the first hydrogen storage vessel.

12. The vehicle according to claim 1, wherein the propulsion system and/or the auxiliary power supply and the set of hydrogen storage devices and mutually releasably coupled.

13. The vehicle according to claim 1, wherein the first hydrogen storage device has at most two planes of symmetry and a shape arranged to reduce drag, in use.

14. The vehicle according to claim 1, wherein the first heater comprises a Joule heater and/or a recirculating heater and the first hydrogen storage device is arranged to interchangeably receive the Joule heater and the recirculating heater therein and/or thereon.

15. The vehicle according to claim 1, wherein the first hydrogen storage device comprises the hydrogen storage material and wherein the hydrogen storage material comprises and/or is a solid hydride and/or a liquid organic hydrogen carrier, LOHC.

16. A charging station for charging a hydrogen storage device for a vehicle according to claim 1.

17. A charging station assembly comprising a hydrogen storage device for a vehicle according to claim 1 and a charging station for charging the hydrogen storage device.

18. A hydrogen storage device for a vehicle,
wherein the vehicle comprises a set of structural components, arranged to provide, at least in part, a structure of the vehicle and to resist, at least in part, internal and/or external forces in one, two or three dimensions; and a propulsion system, arranged to propel the vehicle, and/or an auxiliary power supply, arranged to provide electrical power to the vehicle;
wherein the hydrogen storage device is arranged to provide hydrogen gas to the propulsion system and/or to the auxiliary power supply and wherein the hydrogen storage device comprises:
a pressure vessel, having a first fluid inlet and a first fluid outlet, comprising therein a thermally conducting network thermally coupled to the first heater, wherein the pressure vessel is arranged to receive therein a hydrogen storage material in thermal contact, at least in part, with the thermally conducting network; and wherein the thermally conducting network has a lattice geometry, a gyroidal geometry and/or a fractal geometry in two and/or three dimensions; and
wherein the hydrogen storage device provides a first structural component of the set of structural components.
